(19) United States
(12) Patent Application Publication
(10) Pub. No.: US 2025/0379537 A1
(43) Pub. Date: Dec. 11, 2025

(54) MOTOR CONTROL DEVICE, MOTOR DEVICE, AND STEERING SYSTEM

(71) Applicant: HITACHI ASTEMO, LTD., Hitachinaka-shi, Ibaraki (JP)

(72) Inventor: Makoto KIMURA, Hitachinaka-shi, lbaraki (JP)

(73) Assignee: HITACHI ASTEMO, LTD., Hitachinaka-shi, Ibaraki (JP)

(21) Appl. No.: 18/877,138

(22) PCT Filed: Jun. 13, 2023
(86) PCT No.: PCT/JP2023/021958

§ 371 Date: Dec. 19, 2024

(30) Foreign Application Priority Data
Jul. 5, 2022 (JP) 2022-108569

(51) Int. Cl. H02P 29/02; H02P 27/08

(52) U.S. Cl. CPC H02P 29/02; H02P 27/08

(57) ABSTRACT

A motor control device, a motor device, and a steering system according to the present invention include a third inverter that is connected to a first branch point between a first multi-phase winding set and a first inverter and also to a second branch point between a second multi-phase winding set and a second inverter, switching relays including a first switching relay that is arranged between the first branch point and the third inverter and a second switching relay that is arranged between the second branch point and the third inverter, and a cut-off relay that is arranged between the first branch point and a ground and between the second branch point and the ground. The first switching relay and the second switching relay each have a diode that passes a current in a direction from a motor toward the third inverter, and the cut-off relay has a diode that passes a current in a direction from the ground toward the motor.

### TECHNICAL FIELD

The present invention relates to a motor control device, to a motor device, and to a steering system.

### BACKGROUND ART

A motor control device of Patent Document 1 includes a main motor drive circuit that controls driving of a multi-phase motor, a backup motor drive circuit that controls driving of the multi-phase motor when an abnormality occurs in the main motor drive circuit, and an abnormality diagnosis unit that diagnoses the abnormality of the main motor drive circuit and the backup motor drive circuit. In a normal drive state, only the main motor drive circuit drives the multi-phase motor, and in a backup drive state, when a diagnosis result about the main motor drive circuit obtained by the abnormality diagnosis unit indicates abnormality in the normal drive state, a motor current of a phase output unit in which the abnormality has occurred is cut off and the phase output unit that has been cut off is replaced with a phase output unit of the same phase in the backup motor drive circuit to drive the multi-phase motor.

### REFERENCE DOCUMENT LIST

### Patent Document

Patent Document 1: WO 2015/129271 A1

### SUMMARY OF THE INVENTION

### Problem to be Solved by the Invention

When a motor includes a first multi-phase winding set and a second multi-phase winding set, it is considered that the motor includes, in addition to a first inverter that supplies AC power to the first multi-phase winding set and a second inverter that supplies AC power to the second multi-phase winding set, a third inverter for backing up the first inverter and the second inverter, and when a failure occurs in the first inverter or the second inverter, control on the motor is continued by the third inverter.

Switching of a drive path of a motor has conventionally been carried out by switching supply and cut-off of a current to the drive path by semiconductor switching elements such as field effect transistors (FETs) arranged on the drive path.

However, a current flows in a semiconductor switching element such as a FET, even in a state controlled to be turned OFF, through a parasitic diode (or body diode), which is a diode provided inside.

Thus, when the configuration of switching the drive path by semiconductor switching elements such as FETs is adopted, an output current of an inverter might flow into a normal system through a parasitic diode or a ground-fault circuit might be formed when a short circuit failure occurs in a switching element in the lower arm of an inverter, whereby current control on the first multi-phase winding set or the second multi-phase winding set cannot be normally performed.

The present invention has been made in view of such circumstances, and an object of the present invention is to provide a motor control device, a motor device, and a steering system that enable current control on a first multi-phase winding set and a second multi-phase winding set to be normally performed even if a failure occurs in any of a first inverter, a second inverter, and a third inverter.

### Means for Solving the Problem

One aspect of the present invention includes a first inverter that supplies AC power to a first multi-phase winding set of a motor, a second inverter that supplies AC power to a second multi-phase winding set of the motor, a third inverter that is connected to a first branch point between the first multi-phase winding set and the first inverter and also to a second branch point between the second multi-phase winding set and the second inverter, and that is capable of supplying AC power to the first multi-phase winding set or the second multi-phase winding set, switching relays that include a first switching relay that is arranged between the first branch point and the third inverter, and a second switching relay that is arranged between the second branch point and the third inverter, the first switching relay and the second switching relay each having a diode that passes a current in a direction from the motor toward the third inverter, and a cut-off relay that is arranged between the first branch point and a ground and between the second branch point and the ground, and that has a diode that passes a current in a direction from the ground toward the motor.

### Effects of the Invention

According to the present invention, current control on the first multi-phase winding set and the second multi-phase winding set can be normally performed even if a failure occurs in any of the first inverter, the second inverter, and the third inverter.

### BRIEF DESCRIPTION OF THE DRAWINGS

FIG. 1 is a configuration diagram of a steering system.

FIG. 2 is a block diagram illustrating a configuration of a motor control device.

FIG. 3 is a block diagram illustrating a first embodiment of a detailed configuration of the motor control device.

FIG. 4 is a circuit diagram illustrating details of inverters and relays of the first embodiment.

FIG. 5 is a circuit diagram illustrating a control state when a failure occurs in a first inverter in the first embodiment.

FIG. 6 is a circuit diagram illustrating a control state when a failure occurs in the first inverter in the first embodiment.

FIG. 7 is a block diagram illustrating a second embodiment of a detailed configuration of the motor control device.

FIG. 8 is a circuit diagram illustrating details of inverters and relays of the second embodiment.

FIG. 9 is a circuit diagram illustrating a control state when a failure occurs in the first inverter in the second embodiment.

FIG. 10 is a circuit diagram illustrating a control state when a failure occurs in the first inverter in the second embodiment.

FIG. 11 is a circuit diagram illustrating a control state when a failure occurs in a third inverter in the second embodiment.

FIG. 12 is a circuit diagram illustrating a control state when a failure occurs in the first inverter and a second inverter in the second embodiment.

FIG. 13 is a circuit diagram illustrating a control state when a failure occurs in the first inverter and a fifth relay in the second embodiment.

FIG. 14 is a circuit diagram illustrating a control state when a failure occurs in the third inverter and a fourth relay in the second embodiment.

FIG. 15 is a circuit diagram illustrating a control state when a failure occurs in a third relay and the fourth relay in the second embodiment.

FIG. 16 is a block diagram illustrating a third embodiment of a detailed configuration of the motor control device.

FIG. 17 is a circuit diagram illustrating details of inverters and relays of the third embodiment.

FIG. 18 is a circuit diagram illustrating a control state when a failure occurs in the first inverter in the third embodiment.

FIG. 19 is a circuit diagram illustrating a control state when a failure occurs in the third inverter in the third embodiment.

FIG. 20 is a block diagram illustrating a fourth embodiment of a detailed configuration of the motor control device.

FIG. 21 is a circuit diagram illustrating a control state when a failure occurs in the third inverter in the fourth embodiment.

FIG. 22 is a flowchart illustrating a control procedure performed by a first control device and a second control device.

FIG. 23 is a flowchart illustrating the control procedure performed by the first control device and the second control device.

FIG. 24 is a flowchart illustrating drive switching determination processing based on an accumulated driving time, which is performed by the first control device and the second control device.

FIG. 25 is a flowchart illustrating drive switching determination processing based on an FET estimated temperature, which is performed by the first control device and the second control device.

FIG. 26 is a flowchart illustrating a control procedure performed by a third control device.

FIG. 27 is a flowchart illustrating the control procedure performed by the third control device.

FIG. 28 is a flowchart illustrating drive switching determination processing based on an accumulated driving time, which is carried out by the third control device.

FIG. 29 is a flowchart illustrating drive switching determination processing based on an FET estimated temperature, which is carried out by the third control device.

### MODE FOR CARRYING OUT THE INVENTION

Hereinafter, embodiments of a motor control device, a motor device, and a steering system according to the present invention will be described with reference to the drawings.

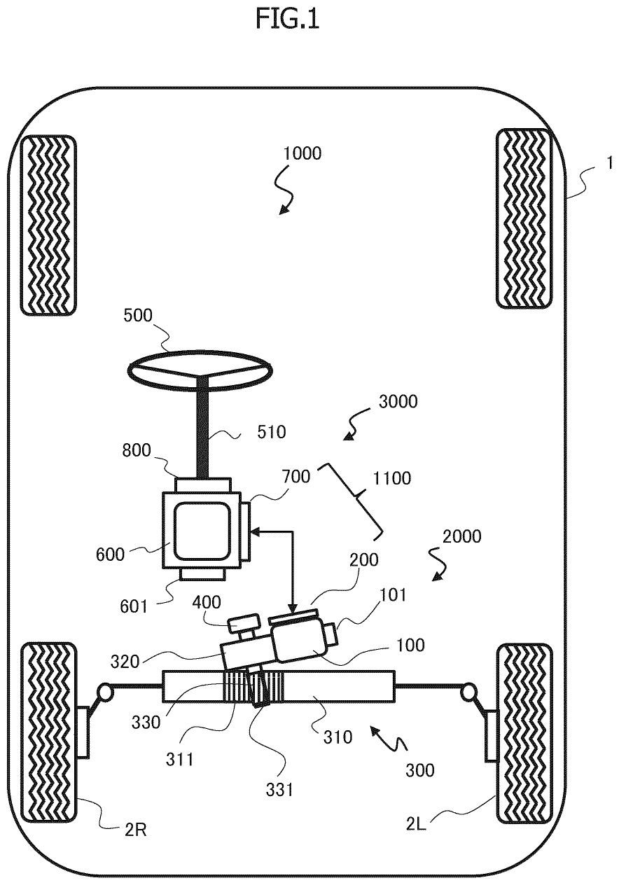

FIG. 1 is a configuration diagram illustrating a mode of a steering system 1000 of a vehicle 1, which is an automobile or the like.

Steering system 1000 includes a steering device 2000 and a reaction force generation device 3000.

Steering device 2000 is a device that is capable of steering front wheels 2L and 2R, which are steered road wheels, through an operation of a motor 100, which is a turning actuator.

Reaction force generation device 3000 is a device that is capable of applying reaction force torque to a steering wheel 500 through operation of a motor 600, which is a reaction force actuator.

Herein, steering device 2000 and reaction force generation device 3000 are mechanically separate from each other.

That is, steering system 1000 is a steer-by-wire steering system in which steering wheel 500 and front wheels 2L and 2R, which are the steered road wheels, are mechanically separate from each other.

Steering system 1000 can include a mechanism in which, if an abnormality occurs in the system, steering device 2000 and reaction force generation device 3000, in other words, front wheels 2L and 2R and steering wheel 500, can be mechanically coupled to each other.

Steering device 2000 includes motor 100 that generates turning force applied to front wheels 2L and 2R, a motor control device 200 that controls motor 100, a turning mechanism 300, and a turning angle detection device 400 that detects the turning angle of front wheels 2L and 2R, in other words, the position of turning mechanism 300.

Motor 100 is a brushless motor and has a motor rotation angle sensor 101 that detects the rotor position, in other words, the rotation angle of an output shaft.

Turning mechanism 300 is a mechanism that converts a rotation motion of the output shaft of motor 100 into a linear motion of a steering rod 310. A rack and a pinion are used in this embodiment.

The rotational driving force of motor 100 is transferred to a pinion shaft 330 via a decelerator 320.

A steering rod 310 has a rack 311 that engages with a pinion 331 provided on pinion shaft 330. When pinion 331 rotates, steering rod 310 horizontally moves in the right or left direction of vehicle 1, thereby changing the angle of front wheels 2L and 2R.

Turning mechanism 300 is not limited to a rack and a pinion, and can be configured as a mechanism through use of a ball screw, for example.

Reaction force generation device 3000 includes steering wheel 500 that is operated by a driver of vehicle 1, a steering shaft 510 that is coupled to steering wheel 500 and rotated with the rotation of steering wheel 500, motor 600 that generates steering reaction force, a motor control device 700 that controls motor 600, and a steering angle detection device 800 that detects the steering angle, which is the operation angle of steering wheel 500.

Motor control device 200 (in other words, a steering control device) of steering device 2000 controls motor 100, which is a turning actuator, by comparing information about a target turning angle based on the steering angle of steering wheel 500 detected by steering angle detection device 800 with information about an actual turning angle detected by turning angle detection device 400.

Motor control device 700 (in other words, a reaction force control device) of reaction force generation device 3000 calculates target reaction force torque based on, for example, information about the steering angle of steering wheel 500 and information about the speed of vehicle 1.

In addition, motor control device 700 controls motor 600, which is a reaction force actuator, to generate steering reaction force based on the target reaction force torque.

Motor 600 is a brushless motor and has a motor rotation angle sensor 601 that detects the rotor position, in other words, the rotation angle of the output shaft.

Motor control device 200 of steering device 2000 and motor control device 700 of reaction force generation device 3000 are configured so as to be capable of communicating with each other.

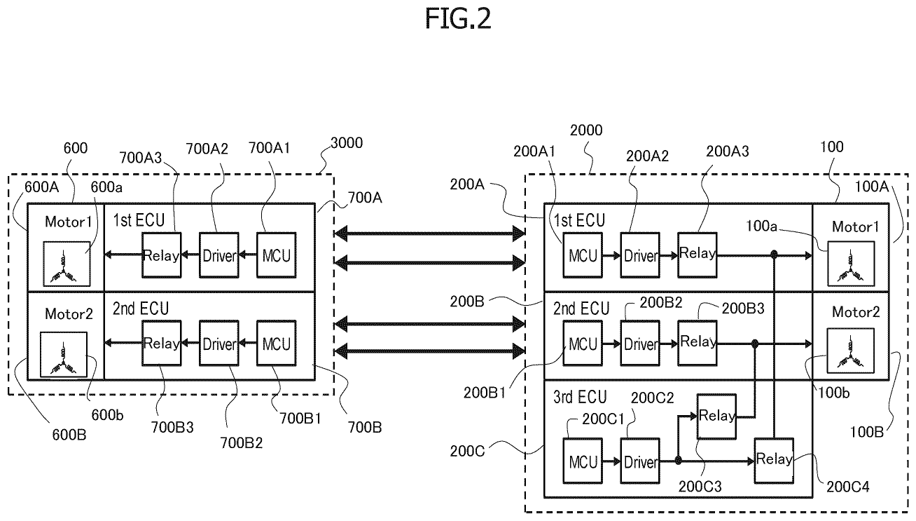

FIG. 2 is a block diagram schematically illustrating a configuration of motor control device 200 of steering device 2000 and motor control device 700 of reaction force generation device 3000.

Steering device 2000 is a device that is capable of steering front wheels 2L and 2R based on the output of motor 100, which is a turning actuator.

Motor 100 is a three-phase brushless motor and has two multi-phase winding sets (three-phase winding sets), each of which is formed by a U-phase coil, a V-phase coil, and a W-phase coil, that is, a first winding set 100a and a second winding set 100b.

In other words, motor 100 has a first motor 100A having first winding set 100a, which is a stator with three-phase windings, and has a second motor 100B having second winding set 100b, which is a stator with three-phase windings.

Steering device 2000 steers front wheels 2L and 2R by operating first motor 100A and second motor 100B in parallel.

Motor control device 200 includes, as control units, a first control device 200A that is connected to first winding set 100a and that is capable of controlling a current supplied to first winding set 100a, a second control device 200B that is connected to second winding set 100b and that is capable of controlling a current supplied to second winding set 100b, and a third control device 200C for backup that is capable of switching connection to, and disconnection from, first winding set 100a and that is capable of switching connection to, and disconnection from, second winding set 100b.

Motor control device 200 and motor 100 constitute the motor device.

First control device 200A is an electronic control unit (ECU) including a first microcontroller unit (MCU) 200A1, a first drive circuit 200A2, and a first relay 200A3.

Second control device 200B is an ECU including a second MCU 200B1, a second drive circuit 200B2, and a second relay 200B3.

Third control device 200C is an ECU including a third MCU 200C1, a third drive circuit 200C2, a third relay 200C3, and a fourth relay 200C4.

Herein, MCUs 200A1 and 200B1, for example, among MCUs 200A1, 200B1, and 200C1 can each be configured as a multi-core MCU including a plurality of processor cores.

For example, if a dual-core MCU is adopted as the multi-core MCU, when an abnormality occurs in a first processor core constituting the dual-core MCU, a second processor core can continue to control its corresponding motor and can continue to monitor its corresponding pre-driver, inverter, power supply, and the like.

The term “MCU” can be referred to as a “microcomputer”, a “processor”, a “processing device”, an “arithmetic device”, or the like.

MCUs 200A1, 200B1, and 200C1 output a control signal for controlling AC power supplied to first motor 100A or second motor 100B to drive circuits 200A2, 200B2, and 200C2.

Drive circuits 200A2, 200B2, and 200C2 include a pre-driver, an inverter, and the like, and supply AC power to first winding set 100a or second winding set 100b.

Turning ON and OFF of first relay 200A3 is controlled by first MCU 200A1 of first control device 200A, whereby connection and disconnection between first drive circuit 200A2 and first winding set 100a are switched.

Turning ON and OFF of second relay 200B3 is controlled by second MCU 200B1 of second control device 200B, whereby connection and disconnection between second drive circuit 200B2 and second winding set 100b are switched.

First relay 200A3 and second relay 200B3 described above are phase relays that are each composed of semiconductor switching elements respectively arranged on three-phase drive lines between the drive circuit and the winding set in first control device 200A and second control device 200B and that switch connection and disconnection between the drive circuit and the winding set.

Turning ON and OFF of third relay 200C3 is controlled by third MCU 200C1 of third control device 200C, whereby connection and disconnection between third drive circuit 200C2 and first winding set 100a are switched.

Turning ON and OFF of a fourth relay 200C4 is controlled by third MCU 200C1 of third control device 200C, whereby connection and disconnection between third drive circuit 200C2 and second winding set 100b are switched.

Third relay 200C3 described above is a first switching relay for switching the circuit that drives first winding set 100a from first drive circuit 200A2 to third drive circuit 200C2. Fourth relay 200C4 is a second switching relay for switching the circuit that drives second winding set 100b from second drive circuit 200B2 to third drive circuit 200C2.

First relay 200A3 can be configured so as to be controlled by third MCU 200C1 of third control device 200C to be turned OFF (a disconnected state).

In addition, first relay 200A3 can be configured so as to be turned OFF when at least one of first MCU 200A1 of first control device 200A and third MCU 200C1 of third control device 200C outputs an OFF command.

Similarly, second relay 200B3 can be configured so as to be controlled by second MCU 200B1 of second control device 200B to be turned OFF.

In addition, second relay 200B3 can be configured so as to be turned OFF when at least one of second MCU 200B1 of second control device 200B and third MCU 200C1 of third control device 200C outputs an OFF command.

First control device 200A monitors presence or absence of a failure in first drive circuit 200A2 and the like.

Second control device 200B monitors presence or absence of a failure in second drive circuit 200B2 and the like.

Third control device 200C monitors presence or absence of a failure in third drive circuit 200C2 and the like.

If a failure occurs in first drive circuit 200A2 of first control device 200A, first relay 200A3 is turned OFF to disconnect first drive circuit 200A2 and first winding set 100a from each other. Instead, third relay 200C3 is turned ON to connect third drive circuit 200C2 and first winding set 100a to each other.

That is, if a failure occurs in first control device 200A that controls first winding set 100a, third control device 200C can control the current supplied to first winding set 100a, in place of first control device 200A.

If a failure occurs in second drive circuit 200B2 of second control device 200B, second relay 200B3 is turned OFF to disconnect second drive circuit 200B2 and second winding set 100b from each other. Instead, fourth relay 200C4 is turned ON to connect third drive circuit 200C2 and second winding set 100b to each other.

That is, if a failure occurs in second control device 200B that controls second winding set 100b, third control device 200C can control the current supplied to second winding set 100b, in place of second control device 200B.

If a failure occurs in third drive circuit 200C2 of third control device 200C, the state in which first drive circuit 200A2 and first winding set 100a are connected to each other and second drive circuit 200B2 and second winding set 100b are connected to each other, that is, a normal state, is maintained.

Therefore, even if a failure occurs in any one of first control device 200A, second control device 200B, and third control device 200C, steering device 2000 can continuously control first motor 100A and second motor 100B, and can continuously steer front wheels 2L and 2R without degrading performance.

In addition, even if a failure occurs in first control device 200A and second control device 200B, steering device 2000 can continuously steer front wheels 2L and 2R by causing third control device 200C to control first motor 100A and second motor 100B.

Reaction force generation device 3000 is a device that is capable of applying reaction force torque to steering wheel 500 based on the output of motor 600, which is a reaction force actuator.

Herein, motor 600 is a three-phase brushless motor and has two multi-phase winding sets, each of which is formed by a U-phase coil, a V-phase coil, and a W-phase coil, that is, a first winding set 600a and a second winding set 600b.

In other words, motor 600 includes a first motor 600A having first winding set 600a, which is a stator with three-phase windings, and has a second motor 600B having second winding set 600b, which is a stator with three-phase windings.

Reaction force generation device 3000 applies reaction force torque to steering wheel 500 by operating first motor 600A and second motor 600B in parallel.

Motor control device 700 includes a first control device 700A that is connected to first winding set 600a and that is capable of controlling a current supplied to first winding set 600a, and includes a second control device 700B that is connected to second winding set 600b and that is capable of controlling a current supplied to second winding set 600b.

First control device 700A includes a first MCU 700A1, a first drive circuit 700A2, and a first relay 700A3.

Second control device 700B includes a second MCU 700B1, a second drive circuit 700B2, and a second relay 700B3.

MCUs 700A1 and 700B1 output a control signal for controlling the AC power supplied to first motor 600A and second motor 600B to drive circuits 700A2 and 700B2, respectively.

Drive circuits 700A2 and 700B2 include a pre-driver, an inverter, etc., and supply the power to first motor 600A and second motor 600B, respectively.

Turning ON and OFF of first relay 700A3 is controlled by first MCU 700A1, whereby connection and disconnection between first drive circuit 700A2 and first winding set 600a are switched.

Turning ON and OFF of second relay 700B3 is controlled by second MCU 700B1, whereby connection and disconnection between second drive circuit 700B2 and second winding set 600b are switched.

As with motor control device 200, motor control device 700 can include a third control device in addition to first control device 700A and second control device 700B.

Motor control device 700 including the third control device is configured such that the third control device controls the current supplied to first winding set 600a when a failure occurs in first control device 700A and such that the third control device controls the current supplied to second winding set 600b when a failure occurs in second control device 700B.

### First Embodiment

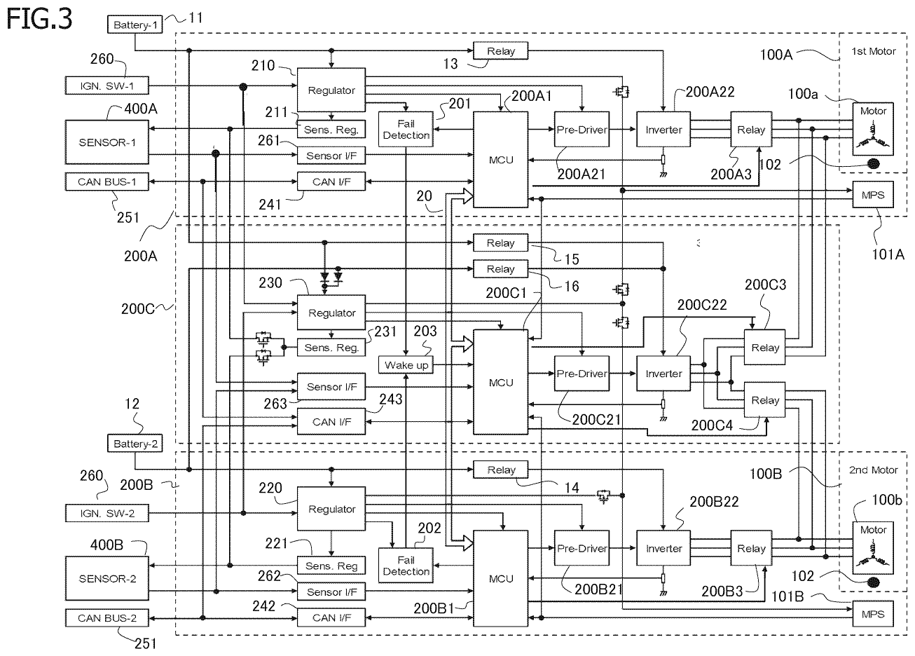

FIG. 3 is a block diagram illustrating a first embodiment of a detailed configuration of motor control device 200.

The elements in FIG. 3 that are the same as those in FIG. 2 are denoted by the same reference characters.

First drive circuit 200A2 of first control device 200A includes a first pre-driver 200A21 and a first inverter 200A22.

Second drive circuit 200B2 of second control device 200B includes a second pre-driver 200B21 and a second inverter 200B22.

Third drive circuit 200C2 of third control device 200C includes a third pre-driver 200C21 and a third inverter 200C22.

Motor 100 includes a first motor rotation angle sensor 101A and a second motor rotation angle sensor 101B as motor rotation angle sensor 101 that detects the rotation angle of the output shaft of motor 100.

First motor rotation angle sensor 101A and second motor rotation angle sensor 101B are magnetic angle sensors, for example, each of which converts a change in magnetic field of a magnet 102 provided at the output shaft of motor 100 into electrical resistance.

First MCU 200A1 and third MCU 200C1 acquire an output signal of first motor rotation angle sensor 101A, and second MCU 200B1 and third MCU 200C1 acquire an output signal of second motor rotation angle sensor 101B.

Vehicle 1 includes a first battery 11, which is a first power supply, and a second battery 12, which is a second power supply.

First inverter 200A22 receives power supply from first battery 11 via a power supply relay 13.

Second inverter 200B22 receives power supply from second battery 12 via a power supply relay 14.

Third inverter 200C22 receives power supply from first battery 11 via a power supply relay 15 and receives power supply from second battery 12 via a power supply relay 16.

MCUs 200A1, 200B1, and 200C1 are connected to a communication line 20 and are configured so as to be capable of communicating with one another.

First control device 200A includes a diagnosis circuit 201 that monitors an operation of first MCU 200A1, and second control device 200B includes a diagnosis circuit 202 that monitors an operation of second MCU 200B1.

A wake-up circuit 203 of third control device 200C acquires a signal indicating a diagnosis result about first MCU 200A1 output from diagnosis circuit 201 and a signal indicating a diagnosis result about second MCU 200B1 output from diagnosis circuit 202.

Upon detecting an abnormality of first MCU 200A1 or second MCU 200B1, wake-up circuit 203 outputs a wake-up signal to third MCU 200C1 to start up third MCU 200C1.

In addition, first control device 200A includes a main voltage regulator 210 and a sensor voltage regulator 211.

Main voltage regulator 210 converts the voltage of first battery 11 into the operating voltage of first MCU 200A1 and the like and supplies the voltage after conversion to first MCU 200A1, first pre-driver 200A21, diagnosis circuit 201, and the like.

Sensor voltage regulator 211 converts the output voltage of main voltage regulator 210 into the operating voltage of a first turning angle sensor 400A constituting turning angle detection device 400, and outputs the voltage after conversion to first turning angle sensor 400A.

Turning angle detection device 400 has a redundant configuration including first turning angle sensor 400A and a second turning angle sensor 400B.

Second control device 200B includes a main voltage regulator 220 and a sensor voltage regulator 221.

Main voltage regulator 220 converts the voltage of second battery 12 into the operating voltage of second MCU 200B1 and the like and supplies the voltage after conversion to second MCU 200B1, second pre-driver 200B21, diagnosis circuit 202, and the like.

Sensor voltage regulator 221 converts the output voltage of main voltage regulator 220 into the operating voltage of second turning angle sensor 400B constituting turning angle detection device 400, and outputs the voltage after conversion to second turning angle sensor 400B.

Third control device 200C includes a main voltage regulator 230 and a sensor voltage regulator 231.

Main voltage regulator 230 converts the voltage of first battery 11 or second battery 12 into the operating voltage of third MCU 200C1 and the like and supplies the voltage after conversion to third MCU 200C1, third pre-driver 200C21, and the like.

Sensor voltage regulator 231 converts the output voltage of main voltage regulator 230 into the operating voltage of first turning angle sensor 400A and second turning angle sensor 400B constituting the turning angle detection device 400, and outputs the voltage after conversion to first turning angle sensor 400A or second turning angle sensor 400B.

That is, first turning angle sensor 400A operates by using the output voltage of sensor voltage regulator 211 or sensor voltage regulator 231 as its power supply voltage.

Second turning angle sensor 400B operates by using the output voltage of sensor voltage regulator 221 or sensor voltage regulator 231 as its power supply voltage.

First motor rotation angle sensor 101A operates by using the output voltage of main voltage regulator 210 or main voltage regulator 230 as its power supply voltage.

Second motor rotation angle sensor 101B operates by using the output voltage of main voltage regulator 220 or main voltage regulator 230 as its power supply voltage.

First MCU 200A1 acquires an output signal of first turning angle sensor 400A via a sensor interface 261.

Second MCU 200B1 acquires an output signal of second turning angle sensor 400B via a sensor interface 262.

Third MCU 200C1 acquires the output signal of first turning angle sensor 400A and the output signal of second turning angle sensor 400B via a sensor interface 263.

First MCU 200A1 is connected to a CAN bus 251 constituting an on-board network via a CAN interface 241.

Second MCU 200B 1 is connected to CAN bus 251 via a CAN interface 242.

Third MCU 200C1 is connected to CAN bus 251 via a CAN interface 243.

First MCU 200A1, second MCU 200B1, and third MCU 200C1 each communicate with the other MCUs connected to CAN bus 251.

Main voltage regulator 210, main voltage regulator 220, and main voltage regulator 230 operate based on a signal from an ignition switch 260.

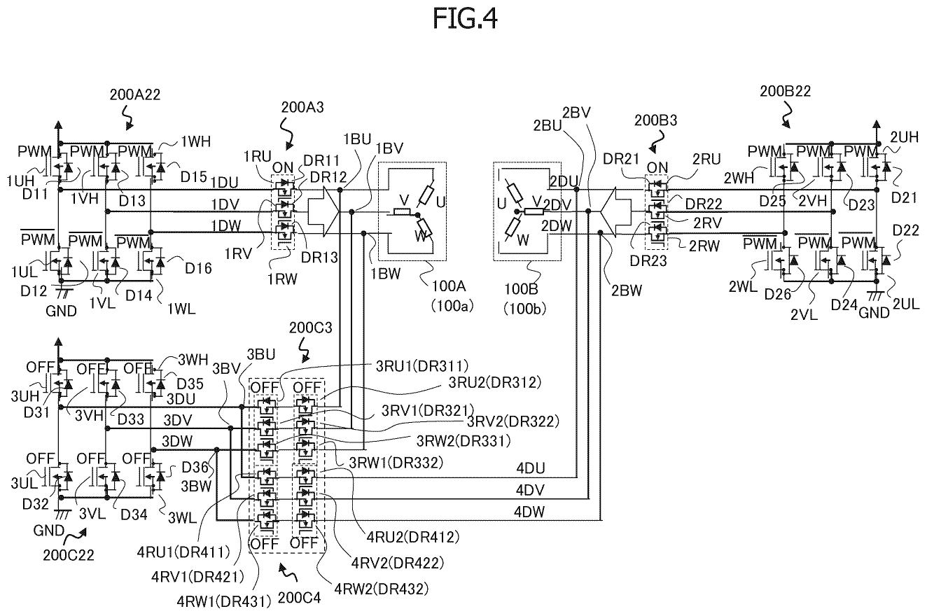

FIG. 4 is a circuit diagram illustrating a detailed configuration of inverters 200A22, 200B22, 200C22 and relays 200A3, 200B3, 200C3, 200C4 illustrated in FIG. 3.

First inverter 200A22 is a three-phase bridge circuit including three pairs of semiconductor switching elements.

Respective semiconductor switching elements 1UH, 1UL, 1VH, 1VL, 1WH, and 1WL constituting first inverter 200A22 are composed of N-channel metal oxide semiconductor field effect transistors (MOS-FETs) respectively having parasitic diodes D11, D12, D13, D14, D15, and D16, each of which is formed between the source terminal and the drain terminal.

In other words, first inverter 200A22 is composed of semiconductor switching elements 1UH, 1VH, and 1WH in respective phases constituting the upper arm and semiconductor switching elements 1UL, 1VL, and 1WL in the respective phases constituting the lower arm.

The parasitic diodes of the N-channel MOS-FETs have their cathodes located on the side of the drain terminal and their anodes located on the side of the source terminal.

Similarly, second inverter 200B22 is a three-phase bridge circuit including three pairs of semiconductor switching elements.

Respective semiconductor switching elements 2UH, 2UL, 2VH, 2VL, 2WH, and 2WL constituting second inverter 200B22 are composed of N-channel MOS-FETs respectively having parasitic diodes D21, D22, D23, D24, D25, and D26, each of which is formed between the source terminal and the drain terminal.

Similarly, third inverter 200C22 is a three-phase bridge circuit including three pairs of semiconductor switching elements.

Respective semiconductor switching elements 3UH, 3UL, 3VH, 3VL, 3WH, and 3WL constituting third inverter 200C22 are composed of N-channel MOS-FETs respectively having parasitic diodes D31, D32, D33, D34, D35, and D36, each of which is formed between the source terminal and the drain terminal.

First relay 200A3 is composed of semiconductor switching elements 1RU, 1RV, and 1RW respectively arranged on first drive lines 1DU, 1DV, and 1DW in the respective phases, which connect first inverter 200A22 and first winding set 100a.

Herein, semiconductor switching elements 1RU, 1RV, and 1RW are N-channel MOS-FETs and are respectively connected to first drive lines 1DU, 1DV, and 1DW such that their drain terminals are located on the side of first winding set 100a and such that their source terminals are located on the side of first inverter 200A22.

Parasitic diodes DR11, DR12, and DR13 of semiconductor switching elements 1RU, 1RV, and 1RW are oriented such that their cathodes are located on the side of first winding set 100a and such that their anodes are located on the side of first inverter 200A22.

That is, semiconductor switching elements 1RU, 1RV, and 1RW constituting first relay 200A3 have parasitic diodes DR11, DR12, and DR13 that pass the current in the direction from first inverter 200A22 toward first winding set 100a.

Similarly, second relay 200B3 is composed of semiconductor switching elements 2RU, 2RV, and 2RW respectively arranged on second drive lines 2DU, 2DV, and 2DW in the respective phases, which connect second inverter 200B22 and second winding set 100b.

Herein, semiconductor switching elements 2RU, 2RV, and 2RW are N-channel MOS-FETs and are connected such that their drain terminals are located on the side of second winding set 100b and such that their source terminals are located on the side of second inverter 200B22.

Parasitic diodes DR21, DR22, and DR23 of semiconductor switching elements 2RU, 2RV, and 2RW are oriented such that their cathodes are located on the side of second winding set 100b and such that their anodes are located on the side of second inverter 200B22.

That is, semiconductor switching elements 2RU, 2RV, and 2RW constituting second relay 200B3 have parasitic diodes DR21, DR22, and DR23 that pass the current in the direction from second inverter 200B22 toward second winding set 100b.

First branch points 1BU, 1BV, and 1BW are respectively provided on first drive lines 1DU, 1DV, and 1DW between first relay 200A3 and first winding set 100a.

Second branch points 2BU, 2BV, and 2BW are respectively provided on second drive lines 2DU, 2DV, and 2DW between second relay 200B3 and second winding set 100b.

Third branch points 3BU, 3BV, and 3BW are respectively provided on third drive lines 3DU, 3DV, and 3DW that respectively connect third inverter 200C22 and first branch points 1BU, 1BV, and 1BW.

Third relay 200C3 is arranged on third drive lines 3DU, 3DV, and 3DW between first branch points 1BU, 1BV, and 1BW and third branch points 3BU, 3BV, and 3BW.

Fourth relay 200C4 is arranged on fourth drive lines 4DU, 4DV, and 4DW in the respective phases, which respectively connect third branch points 3BU, 3BV, and 3BW and second branch points 2BU, 2BV, and 2BW.

Third relay 200C3 is configured by arranging, on each of third drive lines 3DU, 3DV, and 3DW, a pair of two semiconductor switching elements connected in series such that their parasitic diodes are oriented opposite to each other.

Specifically, a semiconductor switching element 3RU1 and a semiconductor switching element 3RU2 are connected in series to each other on third drive line 3DU between first branch point 1BU and third branch point 3BU.

Herein, semiconductor switching element 3RU1 is arranged such that its drain terminal is located on the side of third inverter 200C22 (on the side of third branch point 3BU) and such that its source terminal is located on the side of first winding set 100a (on the side of first branch point 1BU).

Accordingly, parasitic diode DR311 of semiconductor switching element 3RU1 has its anode located on the side of first winding set 100a (on the side of first branch point 1BU) and its cathode located on the side of third inverter 200C22 (on the side of third branch point 3BU).

That is, semiconductor switching element 3RU1 has parasitic diode DR311 that passes the current in the direction from first winding set 100a (first branch point 1BU) toward third inverter 200C22 (third branch point 3BU).

Semiconductor switching element 3RU2 paired with semiconductor switching element 3RU1 is arranged such that its source terminal is located on the side of third inverter 200C22 (on the side of third branch point 3BU) and such that its drain terminal is located on the side of first winding set 100a (on the side of first branch point 1BU).

Accordingly, parasitic diode DR312 of semiconductor switching element 3RU2 has its cathode located on the side of first winding set 100a (on the side of first branch point 1BU) and its anode located on the side of third inverter 200C22 (on the side of third branch point 3BU).

That is, semiconductor switching element 3RU2 has parasitic diode DR312 that passes the current in the direction from third inverter 200C22 (third branch point 3BU) toward first winding set 100a (first branch point 1BU).

As described above, semiconductor switching element 3RU1 and semiconductor switching element 3RU2 are connected in series to each other such that parasitic diodes DR311 and DR312 are oriented opposite to each other.

Similarly, a semiconductor switching element 3RV1 and a semiconductor switching element 3RV2 are connected in series to each other on third drive line 3DV between first branch point 1BV and third branch point 3BV such that parasitic diodes DR321 and DR322 are oriented opposite to each other.

A semiconductor switching element 3RW1 and a semiconductor switching element 3RW2 are connected in series to each other on third drive line 3DW between first branch point 1BW and third branch point 3BW such that parasitic diodes DR331 and DR332 are oriented opposite to each other.

As with third relay 200C3, fourth relay 200C4 is configured by arranging, on each of fourth drive lines 4DU, 4DV, and 4DW, a pair of two semiconductor switching elements connected in series such that their parasitic diodes are oriented opposite to each other.

Specifically, a semiconductor switching element 4RU1 and a semiconductor switching element 4RU2 are connected in series to each other on fourth drive line 4DU between second branch point 2BU and third branch point 3BU such that parasitic diodes DR411 and DR412 are oriented opposite to each other.

A semiconductor switching element 4RV1 and a semiconductor switching element 4RV2 are connected in series to each other on fourth drive line 4DV between second branch point 2BV and third branch point 3BV such that parasitic diodes DR421 and DR422 are oriented opposite to each other.

A semiconductor switching element 4RW1 and a semiconductor switching element 4RW2 are connected in series to each other on fourth drive line 4DW between second branch point 2BW and third branch point 3BW such that parasitic diodes DR431 and DR432 are oriented opposite to each other.

Herein, first relay 200A3 is a relay that is arranged between first branch points 1BU, 1BV, and 1BW and a ground GND of first inverter 200A22 and that has the parasitic diodes that pass the current in the direction from the ground GND of first inverter 200A22 toward first winding set 100a (first motor 100A).

Second relay 200B3 is a relay that is arranged between second branch points 2BU, 2BV, and 2BW and the ground GND of second inverter 200B22 and that has the parasitic diodes that pass the current in the direction from the ground GND of second inverter 200B22 toward second winding set 100b (second motor 100B).

Semiconductor switching elements 3RU2, 3RV2, and 3RW2 constituting third relay 200C3 are arranged between first branch points 1BU, 1BV, and 1BW and the ground GND of first inverter 200A22.

In addition, semiconductor switching elements 3RU2, 3RV2, and 3RW2 constituting third relay 200C3 each have the parasitic diode that passes the current in the direction from the ground GND of third inverter 200C22 toward first winding set 100a (first branch points 1BU, 1BV, and 1BW).

Semiconductor switching elements 4RU2, 4RV2, and 4RW2 constituting fourth relay 200C4 are arranged between second branch points 2BU, 2BV, and 2BW and the ground GND of third inverter 200C22.

In addition, semiconductor switching elements 4RU2, 4RV2, and 4RW2 constituting fourth relay 200C4 are relays each having the parasitic diode that passes the current in the direction from the ground GND of third inverter 200C22 toward second winding set 100b (second branch points 2BU, 2BV, and 2BW).

A control state of the semiconductor switching elements constituting inverters 200A22, 200B22, and 200C22 and relays 200A3, 200B3, 200C3, and 200C4 illustrated in FIG. 4 is a case in which first inverter 200A22 (first drive circuit A2) and second inverter 200B22 (second drive circuit B2) are normal.

Therefore, in the control state illustrated in FIG. 4, AC power is supplied from first inverter 200A22 to first winding set 100a, and AC power is supplied from second inverter 200B22 to second winding set 100b.

At this time, turning ON and OFF of each of semiconductor switching elements 1UH, 1UL, 1VH, 1VL, 1WH, and 1WL of first inverter 200A22 and each of semiconductor switching elements 2UH, 2UL, 2VH, 2VL, 2WH, and 2WL of second inverter 200B22 are subjected to pulse width modulation (PWM) control based on a turning angle command or a turning force command.

Semiconductor switching elements 1RU, 1RV, and 1RW of first relay 200A3 and semiconductor switching elements 2RU, 2RV, and 2RW of second relay 200B3 are held in the ON-state.

Each of semiconductor switching elements 3UH, 3UL, 3VH, 3VL, 3WH, and 3WL of third inverter 200C22 is held in the OFF-state.

Semiconductor switching elements 3RU1, 3RU2, 3RV1, 3RV2, 3RW1, and 3RW2 of third relay 200C3 are held in the OFF-state.

Semiconductor switching elements 4RU1, 4RU2, 4RV1, 4RV2, 4RW1, and 4RW2 of fourth relay 200C4 are held in the OFF-state.

Herein, since third relay 200C3 and fourth relay 200C4 are each configured by connecting in series two semiconductor switching elements having their parasitic diodes oriented opposite to each other, the current is prevented from flowing through the parasitic diodes when each of the semiconductor switching elements is in the OFF-state.

That is, in the OFF-state of third relay 200C3 and fourth relay 200C4, the output current of first inverter 200A22 and the output current of second inverter 200B22 do not flow to the side of third inverter 200C22 through third relay 200C3 or fourth relay 200C4.

Specifically, semiconductor switching elements 3RU2, 3RV2, and 3RW2 constituting third relay 200C3 each function as a cut-off relay that prevents the output current of first inverter 200A22 from flowing to the side of third inverter 200C22.

In addition, semiconductor switching elements 4RU2, 4RV2, and 4RW2 constituting fourth relay 200C4 each function as a cut-off relay that prevents the output current of second inverter 200B22 from flowing to the side of third inverter 200C22.

Therefore, even if a short circuit failure occurs in semiconductor switching elements 3UL, 3VL, and 3WL of the lower arm of third inverter 200C22, the current is cut off by third relay 200C3 and fourth relay 200C4.

Thus, a ground-fault circuit that goes through semiconductor switching element 3UL, 3VL, and 3WL in which a short circuit failure has occurred is prevented from being formed, whereby current control on first winding set 100a and second winding set 100b can be normally performed.

In addition, the output current of first inverter 200A22 is prevented from flowing into second winding set 100b through third relay 200C3 and fourth relay 200C4, and the output current of second inverter 200B22 is prevented from flowing into first winding set 100a through fourth relay 200C4 and third relay 200C3.

Therefore, the current control on first winding set 100a and second winding set 100b is normally performed.

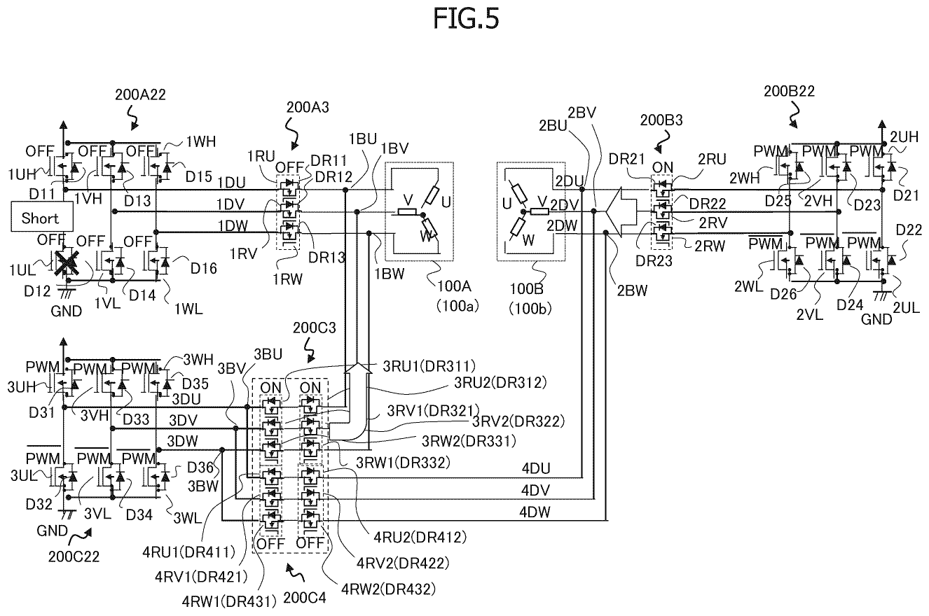

FIG. 5 illustrates a control state when a short circuit failure occurs in semiconductor switching element 1UL of the lower arm among semiconductor switching elements 1UH, 1UL, 1VH, 1VL, 1WH, and 1WL constituting first inverter 200A22.

Herein, since a failure has occurred in first inverter 200A22, AC power is supplied from third inverter 200C22 for backup, in place of first inverter 200A22, to first winding set 100a.

At this time, each of semiconductor switching elements 1UH, 1UL, 1VH, 1VL, 1WH, and 1WL of first inverter 200A22 is switched from the PWM control state to the OFF-state, and semiconductor switching elements 1RU, 1RV, and 1RW of first relay 200A3 are switched from the ON-state to the OFF-state.

In order to cause third inverter 200C22 to supply AC power to first winding set 100a, the PWM control on each of semiconductor switching elements 3UH, 3UL, 3VH, 3VL, 3WH, and 3WL of third inverter 200C22 is started, and semiconductor switching elements 3RU1, 3RU2, 3RV1, 3RV2, 3RW1, and 3RW2 of third relay 200C3 are switched from the OFF-state to the ON-state.

Accordingly, AC power is supplied from third inverter 200C22 to first winding set 100a, whereby supply of AC power to first winding set 100a can be continued even if a failure occurs in first inverter 200A22.

Herein, first relay 200A3 prevents a ground fault of the AC power supplied from third inverter 200C22 to first winding set 100a via semiconductor switching element 1UL in which a short circuit failure has occurred.

First relay 200A3 is a relay that is arranged between first branch points 1BU, 1BV, and 1BW and the ground GND of first inverter 200A22 and that has the parasitic diode that passes the current in the direction from the ground GND of first inverter 200A22 toward first winding set 100a (first branch points 1BU, 1BV, and 1BW).

Thus, when a failure occurs in first inverter 200A22, first relay 200A3 is switched to the OFF-state to function as a cut-off relay that cuts off the AC power supplied from third inverter 200C22 to first winding set 100a flowing into first inverter 200A22.

Since second inverter 200B22 is normal, the PWM control on semiconductor switching elements 2UH, 2UL, 2VH, 2VL, 2WH, and 2WL of second inverter 200B22 is continued, and the ON-state of semiconductor switching elements 2RU, 2RV, and 2RW of second relay 200B3 is also continued.

In addition, the OFF-state of semiconductor switching elements 4RU1, 4RU2, 4RV1, 4RV2, 4RW1, and 4RW2 of fourth relay 200C4 is continued.

Accordingly, even if a failure occurs in first inverter 200A22, AC power is supplied to second winding set 100b from second inverter 200B22.

Semiconductor switching elements 4RU1, 4RU2, 4RV1, 4RV2, 4RW1, and 4RW2 of fourth relay 200C4 are held in the OFF-state, and fourth relay 200C4 is configured by combining two semiconductor switching elements such that their parasitic diodes are oriented opposite to each other.

Thus, the output current of third inverter 200C22 is prevented from flowing into second drive lines 2DU, 2DV, and 2DW of second winding set 100b via the parasitic diodes of semiconductor switching elements 4RU1, 4RU2, 4RV1, 4RV2, 4RW1, and 4RW2.

In addition, semiconductor switching elements 4RU2, 4RV2, and 4RW2 constituting fourth relay 200C4 each function as a cut-off relay that prevents the output current of second inverter 200B22 from flowing to the side of third inverter 200C22.

Therefore, even if a failure occurs in first inverter 200A22, the control on first winding set 100a and second winding set 100b can be normally performed.

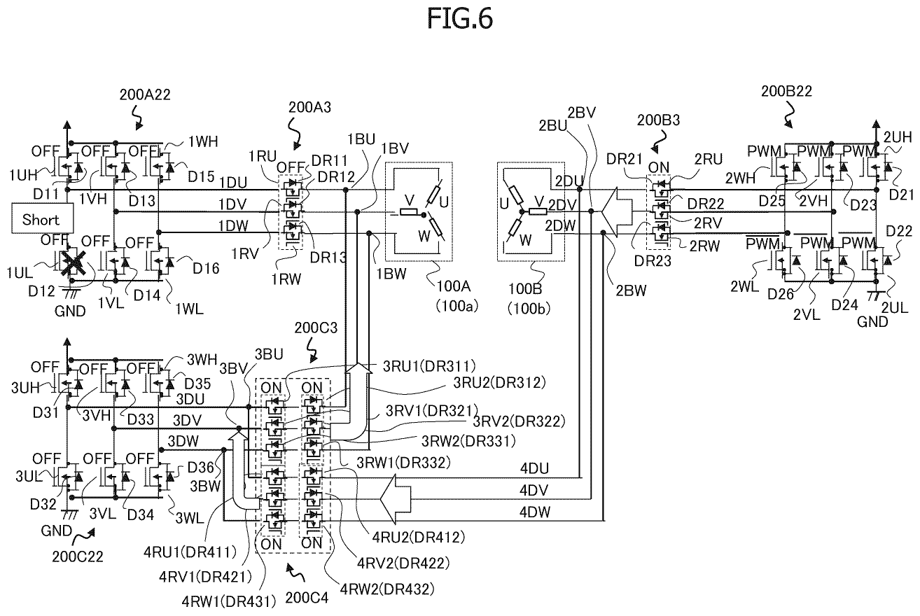

As with the case in FIG. 5, FIG. 6 illustrates another mode of the control state when a short circuit failure occurs in semiconductor switching element 1UL among semiconductor switching elements 1UH, 1UL, 1VH, 1VL, 1WH, and 1WL constituting first inverter 200A22.

In the control mode illustrated in FIG. 6, AC power is supplied from second inverter 200B22, in place of first inverter 200A22 in which a failure has occurred, to first winding set 100a.

That is, when a failure occurs in first inverter 200A22, AC power is supplied from second inverter 200B22, which is normal, to first winding set 100a and second winding set 100b without operating third inverter 200C22 for backup.

At this time, each of semiconductor switching elements 1UH, 1UL, 1VH, 1VL, 1WH, and 1WL of first inverter 200A22 is switched from the PWM control state to the OFF-state, and semiconductor switching elements 1RU, 1RV, and 1RW of first relay 200A3 are switched from the ON-state to the OFF-state.

Respective semiconductor switching elements 3UH, 3UL, 3VH, 3VL, 3WH, and 3WL of third inverter 200C22 are held in the OFF-state as they are without transitioning to the PWM control state.

Semiconductor switching elements 3RU1, 3RU2, 3RV1, 3RV2, 3RW1, and 3RW2 of third relay 200C3 and semiconductor switching elements 4RU1, 4RU2, 4RV1, 4RV2, 4RW1, and 4RW2 of fourth relay 200C4 are switched from the OFF-state to the ON-state.

Accordingly, the output current of second inverter 200B22 is supplied to first winding set 100a via second branch points 2BU, 2BV, and 2BW, fourth relay 200C4, third branch points 3BU, 3BV, and 3BW, third relay 200C3, and first branch points 1BU, 1BV, and 1BW.

Herein, semiconductor switching elements 1RU, 1RV, and 1RW of first relay 200A3 are in the OFF-state, and parasitic diodes DR11, DR12, and DR13 pass the current in the direction from first inverter 200A22 toward first winding set 100a, but do not send the current flowing from first winding set 100a toward first inverter 200A22.

Thus, AC power output from second inverter 200B22 and flowed into first drive lines 1DU, 1DV, and 1DW via first branch points 1BU, 1BV, and 1BW is supplied to first winding set 100a without flowing to the side of first inverter 200A22.

That is, first relay 200A3 functions as a cut-off relay that prevents the current output from second inverter 200B22 from flowing to the side of first inverter 200A22.

### Second Embodiment

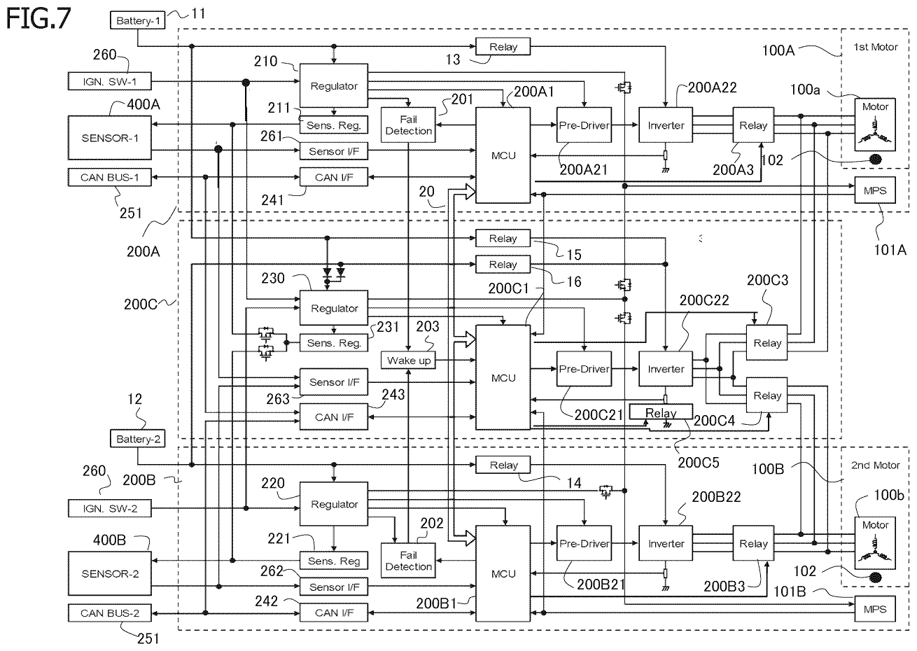

FIG. 7 is a block diagram illustrating a second embodiment of a detailed configuration of motor control device 200.

The elements in FIG. 7 that are the same as those in FIG. 3 are denoted by the same reference characters, and detailed description thereof will thus be omitted.

Motor control device 200 in FIG. 7 is different from motor control device 200 in FIG. 3 in that a fifth relay 200C5 is arranged between third inverter 200C22 and the ground GND. Turning ON and OFF of fifth relay 200C5 is controlled by third MCU 200C1 of third control device 200C.

Motor control device 200 in FIG. 7 includes third relay 200C3 and fourth relay 200C4 as with motor control device 200 in FIG. 3, but is different in that semiconductor switching elements 3RU2, 3RV2, 3RW2, 4RU2, 4RV2, and 4RW2 are omitted, as will be specifically described later.

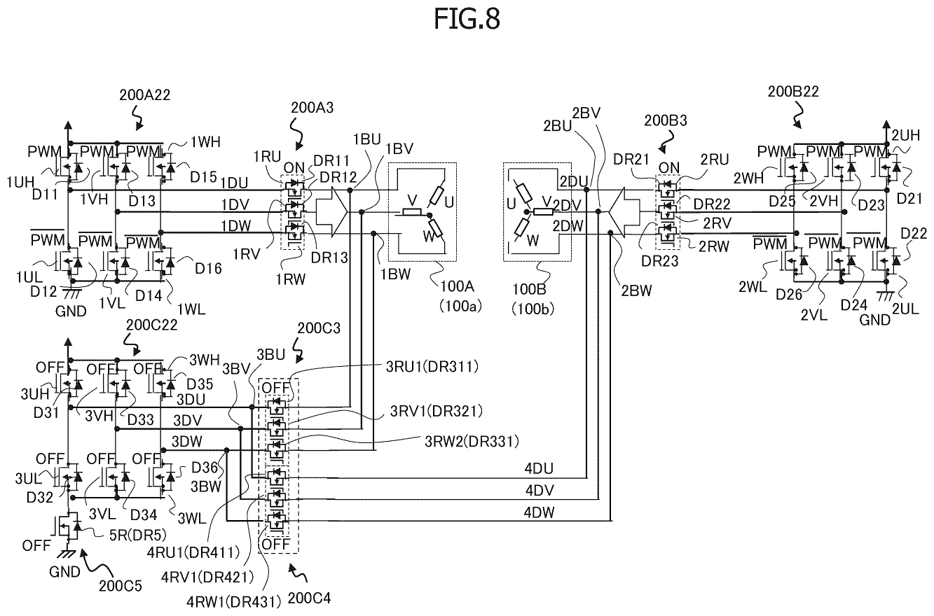

FIG. 8 is a circuit diagram illustrating a detailed configuration of inverters 200A22, 200B22, and 200C22, and relays 200A3, 200B3, 200C3, 200C4, and 200C5 illustrated in FIG. 7. The elements in FIG. 8 that are the same as those in FIG. 4 are denoted by the same reference characters, and detailed description thereof will thus be omitted.

Fifth relay 200C5 is composed of a semiconductor switching element 5R arranged between third inverter 200C22 and the ground GND.

Herein, semiconductor switching element 5R constituting fifth relay 200C5 is an N-channel MOS-FET and is connected such that its drain terminal is located on the side of third inverter 200C22 and such that its source terminal is located on the side of the ground GND.

A parasitic diode DR5 of semiconductor switching element 5R is oriented such that its cathode is located on the side of third inverter 200C22 and such that its anode is located on the side of the ground GND.

That is, semiconductor switching element 5R constituting fifth relay 200C5 has parasitic diode DR5 that passes the current in the direction from the ground GND toward third inverter 200C22.

In other words, fifth relay 200C5 is arranged between first branch points 1BU, 1BV, and 1BW and the ground GND of third inverter 200C22, and is arranged between second branch points 2BU, 2BV, and 2BW and the ground GND of third inverter 200C22.

In addition, fifth relay 200C5 has a parasitic diode that passes the current in the direction from the ground GND of third inverter 200C22 toward motor 100 and functions as a cut-off relay that cuts off a ground-fault path to the ground GND of third inverter 200C22.

Third relay 200C3 of the second embodiment illustrated in FIG. 8 is composed of semiconductor switching elements 3RU1, 3RV1, and 3RW1 by omitting semiconductor switching elements 3RU2, 3RV2, and 3RW2 from third relay 200C3 of the first embodiment illustrated in FIG. 4.

Herein, parasitic diodes DR311, DR321, and DR331 of semiconductor switching elements 3RU1, 3RV1, and 3RW1 have their anodes located on the side of first winding set 100a (on the side of first branch points 1BU, 1BV, and 1BW) and their cathodes located on the side of third inverter 200C22 (on the side of third branch points 3BU, 3BV, and 3BW).

That is, semiconductor switching elements 3RU1, 3RV1, and 3RW1 constituting third relay 200C3 of the second embodiment illustrated in FIG. 8 have parasitic diodes DR311, DR321, and DR331 that pass the current in the direction from first winding set 100a (first branch points 1BU, 1BV, and 1BW) toward third inverter 200C22 (third branch points 3BU, 3BV, and 3BW).

Fourth relay 200C4 of the second embodiment illustrated in FIG. 8 is composed of semiconductor switching element 4RU1, 4RV1, and 4RW1 by omitting semiconductor switching elements 4RU2, 4RV2, and 4RW2 from fourth relay 200C4 of the first embodiment illustrated in FIG. 4.

Herein, parasitic diodes DR411, DR421, and DR431 of semiconductor switching elements 4RU1, 4RV1, and 4RW1 have their anodes located on the side of second winding set 100b (on the side of second branch points 2BU, 2BV, and 2BW) and their cathodes located on the side of third inverter 200C22 (on the side of third branch points 3BU, 3BV, and 3BW).

That is, semiconductor switching elements 4RU1, 4RV1, and 4RW1 constituting fourth relay 200C4 of the second embodiment illustrated in FIG. 8 have parasitic diodes DR411, DR421, and DR431 that pass the current in the direction from second winding set 100b (second branch points 2BU, 2BV, and 2BW) toward third inverter 200C22 (third branch points 3BU, 3BV, and 3BW).

In the case of this second embodiment, the number of semiconductor switching elements constituting third relay 200C3 and fourth relay 200C4 is reduced by half of that in the first embodiment although semiconductor switching element 5R constituting fifth relay 200C5 is added.

Accordingly, motor control device 200 of the second embodiment enables the total number of semiconductor switching elements to be reduced by five as compared with motor control device 200 of the first embodiment.

The control state of each of the semiconductor switching elements constituting inverters 200A22, 200B22, and 200C22 and relays 200A3, 200B3, 200C3, 200C4, and 200C5 illustrated in FIG. 8 illustrates a control state in which first inverter 200A22 and second inverter 200B22 are normal, whereby AC power is supplied from first inverter 200A22 to first winding set 100a, and AC power is supplied from second inverter 200B22 to second winding set 100b.

At this time, the turning ON and OFF of each of semiconductor switching elements 1UH, 1UL, 1VH, 1VL, 1WH, and 1WL of first inverter 200A22 and each of semiconductor switching elements 2UH, 2UL, 2VH, 2VL, 2WH, and 2WL of second inverter 200B22 is subjected to pulse width modulation (PWM) control based on the turning angle command or the turning force command.

Semiconductor switching elements 1RU, 1RV, and 1RW of first relay 200A3 and semiconductor switching elements 2RU, 2RV, and 2RW of second relay 200B3 are held in the ON-state.

Each of semiconductor switching elements 3UH, 3UL, 3VH, 3VL, 3WH, and 3WL of third inverter 200C22 is held in the OFF-state.

Semiconductor switching elements 3RU1, 3RV1, and 3RW1 of third relay 200C3 are held in the OFF-state.

Semiconductor switching elements 4RU1, 4RV1, and 4RW1 of fourth relay 200C4 are held in the OFF-state.

Semiconductor switching element 5R of fifth relay 200C5 is held in the OFF-state.

Herein, parasitic diodes DR311, DR321, DR331, DR411, DR421, and DR431 of respective semiconductor switching elements 3RU1, 3RV1, 3RW1, 4RU1, 4RV1, and 4RW1 constituting third relay 200C3 and fourth relay 200C4 pass the current in the direction from first winding set 100a or second winding set 100b toward third inverter 200C22.

However, each of semiconductor switching elements 3UL, 3VL, and 3WL constituting the lower arm of third inverter 200C22 is OFF, and parasitic diodes D32, D34, and D36 of respective semiconductor switching elements 3UL, 3VL, and 3WL do not pass the current from the sides of third relay 200C3 and fourth relay 200C4 to the side of the ground GND.

Semiconductor switching element 5R of fifth relay 200C5 is also OFF, and parasitic diode DR5 of semiconductor switching element 5R does not pass the current to the sides of third relay 200C3 and fourth relay 200C4 to the side of the ground GND.

Therefore, a ground-fault circuit via each of semiconductor switching elements 3UL, 3VL, and 3WL constituting the lower arm of third inverter 200C22 and semiconductor switching element 5R of fifth relay 200C5 is not formed.

Thus, the current control on first winding set 100a and second winding set 100b is normally performed.

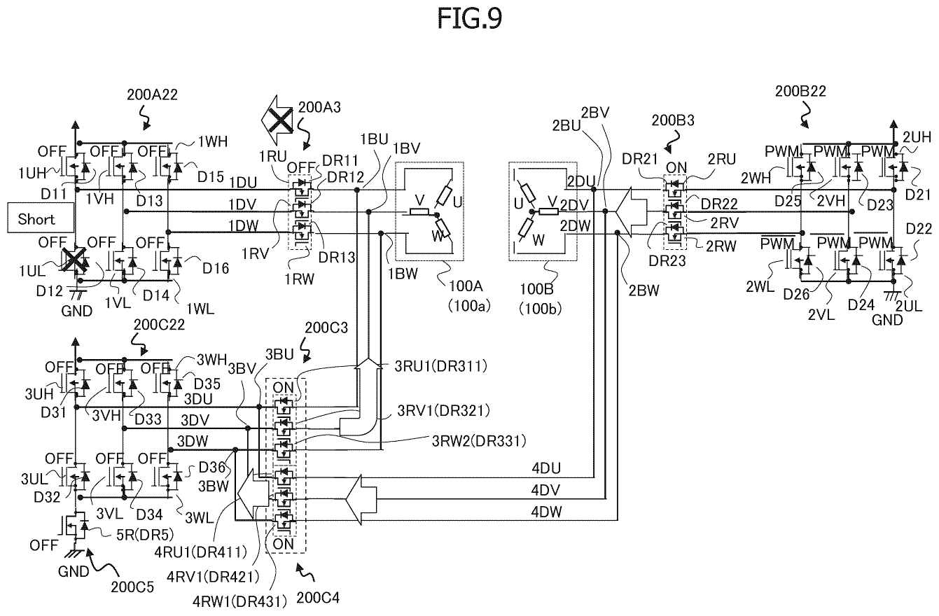

FIG. 9 illustrates a control state of each of the semiconductor switching elements constituting inverters 200A22, 200B22, and 200C22 and relays 200A3, 200B3, 200C3, 200C4, and 200C5 when a short circuit failure occurs in semiconductor switching element 1UL of the lower arm among semiconductor switching elements 1UH, 1UL, 1VH, 1VL, 1WH, and 1WL constituting first inverter 200A22 in the second embodiment.

Herein, AC power is supplied from second inverter 200B22, in place of first inverter 200A22 in which a failure has occurred, to first winding set 100a, and second inverter 200B22 supplies AC power to second winding set 100b and first winding set 100a.

Since a failure occurs in first inverter 200A22, the PWM control on first inverter 200A22 is stopped.

Each of semiconductor switching elements 1RU, 1RV, and 1RW constituting first relay 200A3 is switched from the ON-state to the OFF-state.

Each of semiconductor switching elements 3UH, 3UL, 3VH, 3VL, 3WH, and 3WL of third inverter 200C22 is held in the OFF-state.

Semiconductor switching element 5R of fifth relay 200C5 is also held in the OFF-state.

Each of semiconductor switching elements 3RU1, 3RV1, and 3RW1 constituting third relay 200C3 and each of semiconductor switching elements 4RU1, 4RV1, and 4RW1 constituting fourth relay 200C4 are switched from the OFF-state to the ON-state.

In this case, the output current of second inverter 200B22 passes through second branch points 2BU, 2BV, and 2BW and each of semiconductor switching elements 4RU1, 4RV1, and 4RW1 constituting fourth relay 200C4 to reach third branch points 3BU, 3BV, and 3BW.

Herein, each of semiconductor switching elements 3UH, 3UL, 3VH, 3VL, 3WH, and 3WL of third inverter 200C22 is in the OFF-state, while each of semiconductor switching elements 3RU1, 3RV1, and 3RW1 constituting third relay 200C3 is in the ON-state.

Thus, the output current of second inverter 200B22 passes through third branch points 3BU, 3BV, and 3BW and third relay 200C3 to reach first branch points 1BU, 1BV, and 1BW.

Each of semiconductor switching elements 1RU, 1RV, and 1RW constituting first relay 200A3 is OFF, and parasitic diodes DR11, DR12, and DR13 of semiconductor switching elements 1RU, 1RV, and 1RW are oriented such that their cathodes are located on the side of first winding set 100a and such that their anodes are located on the side of first inverter 200A22.

Thus, the output current of second inverter 200B22 having reached first branch points 1BU, 1BV, and 1BW is supplied to first winding set 100a through first branch points 1BU, 1BV, and 1BW without flowing to the side of first inverter 200A22 through each of semiconductor switching elements 1RU, 1RV, and 1RW constituting first relay 200A3.

That is, when a failure occurs in first inverter 200A22 (when a short circuit failure occurs in a semiconductor switching element of the lower arm), first relay 200A3 functions as a cut-off relay to prevent a ground-fault circuit from being formed, whereby first winding set 100a and second winding set 100b can be normally controlled by second inverter 200B22.

In addition, in the case of the first embodiment, first winding set 100a and second winding set 100b can be normally controlled if a failure occurs in first inverter 200A22 as illustrated in FIG. 5 and FIG. 6.

However, in the second embodiment, first winding set 100a and second winding set 100b can be normally controlled when a failure occurs in first inverter 200A22 in the circuit in which the number of semiconductor switching elements constituting the relays is reduced as compared with that of the first embodiment.

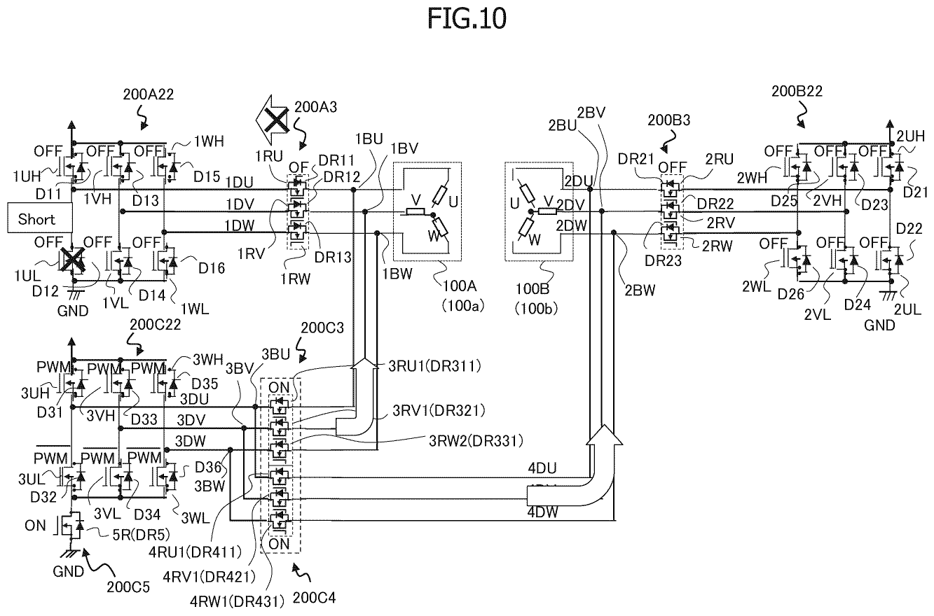

FIG. 10 illustrates a control state of each of the semiconductor switching elements when a short circuit failure occurs in semiconductor switching element 1UL of first inverter 200A22 in the second embodiment, as with the failure mode in FIG. 9.

Herein, the normal state in which first inverter 200A22 supplies AC power to first winding set 100a and second inverter 200B22 supplies AC power to second winding set 100b is switched to a state in which third inverter 200C22 supplies AC power to first winding set 100a and second winding set 100b when a failure occurs in first inverter 200A22.

Specifically, when a failure occurs in first inverter 200A22, the PWM control on first inverter 200A22 and second inverter 200B22 is stopped.

Each of semiconductor switching elements 1RU, 1RV, and 1RW constituting first relay 200A3 is switched from the ON-state to the OFF-state, and semiconductor switching elements 2RU, 2RV, and 2RW of second relay 200B3 are also switched from the ON-state to the OFF-state.

The PWM control on each of semiconductor switching elements 3UH, 3UL, 3VH, 3VL, 3WH, and 3WL of third inverter 200C22 is started.

Each of semiconductor switching elements 3RU1, 3RV1, and 3RW1 constituting third relay 200C3 and each of semiconductor switching elements 4RU1, 4RV1, and 4RW1 constituting fourth relay 200C4 are switched from the OFF-state to the ON-state.

In this control state, the output current of third inverter 200C22 is supplied to first winding set 100a through third relay 200C3 and first branch points 1BU, 1BV, and 1BW, and the output current of third inverter 200C22 is supplied to second winding set 100b through fourth relay 200C4 and second branch points 2BU, 2BV, and 2BW.

Herein, a short circuit failure has occurred in semiconductor switching element 1UL of first inverter 200A22.

However, each of semiconductor switching elements 1RU, 1RV, and 1RW constituting first relay 200A3 is OFF, and parasitic diodes DR11, DR12, and DR13 of semiconductor switching elements 1RU, 1RV, and 1RW are oriented such that their cathodes are located on the side of first winding set 100a and such that their anodes are located on the side of first inverter 200A22.

Thus, first relay 200A3 that functions as a cut-off relay prevents the output current of third inverter 200C22 from flowing into first inverter 200A22, whereby formation of a ground-fault circuit via semiconductor switching element 1UL in which a short circuit failure has occurred is avoided.

Therefore, when a failure occurs in first inverter 200A22, AC power can be normally supplied from third inverter 200C22 to first winding set 100a and second winding set 100b.

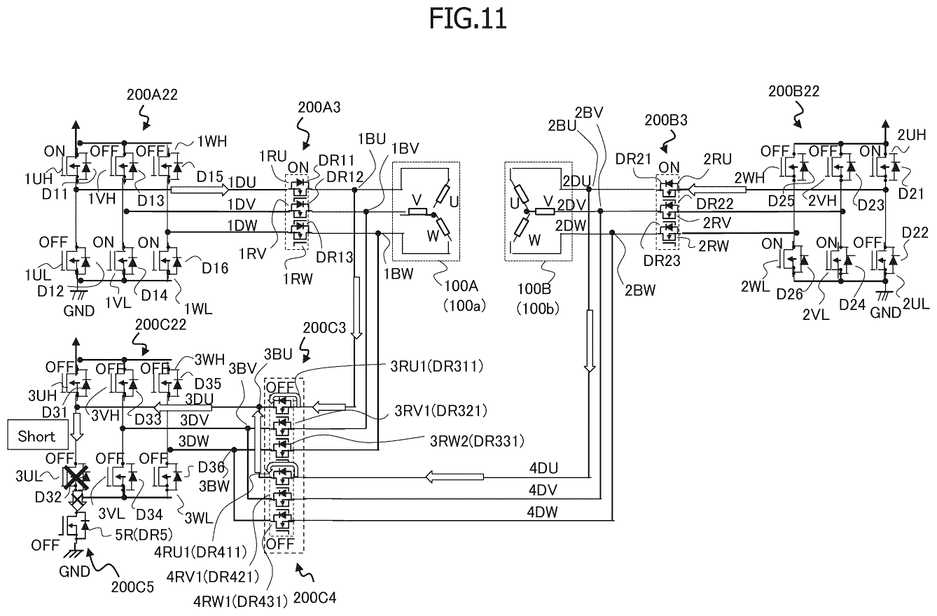

FIG. 11 illustrates that even if a short circuit failure occurs in semiconductor switching element 3UL of the lower arm of third inverter 200C22 in the state in which first inverter 200A22 supplies AC power to first winding set 100a and in which second inverter 200B22 supplies AC power to second winding set 100b in the second embodiment, a ground-fault circuit that goes through semiconductor switching element 3UL is not formed.

In the state in which first inverter 200A22 supplies AC power to first winding set 100a and in which second inverter 200B22 supplies AC power to second winding set 100b, each of semiconductor switching elements 3RU1, 3RV1, and 3RW1 constituting third relay 200C3 and each of semiconductor switching elements 4RU1, 4RV1, and 4RW1 constituting fourth relay 200C4 are held in the OFF-state.

However, parasitic diodes DR311, DR321, DR331, DR411, DR421, and DR431 of respective semiconductor switching elements 3RU1, 3RV1, 3RW1, 4RU1, 4RV1, and 4RW1 have their cathodes located on the side of third inverter 200C22 and their anodes located on the side of motor 100.

Thus, the current supplied to first winding set 100a and second winding set 100b can pass through parasitic diodes DR311, DR321, DR331, DR411, DR421, and DR431 to flow into third inverter 200C22.

However, semiconductor switching element 5R constituting fifth relay 200C5 is held in the OFF-state, and the orientation of parasitic diode DR5 of semiconductor switching element 5R is set such that its cathode is located on the side of third inverter 200C22 and such that its anode is located on the side of the ground GND.

Therefore, semiconductor switching element 5R (and parasitic diode DR5) cuts off a ground-fault path, whereby a ground-fault circuit that goes through semiconductor switching element 3UL in which a short circuit failure has occurred is not formed.

That is, fifth relay 200C5 functions as a cut-off relay that cuts off the ground-fault path via semiconductor switching element 3UL in which a short circuit failure has occurred.

Thus, even if a short circuit failure occurs in semiconductor switching element 3UL of the lower arm of third inverter 200C22, a ground fault of the output current of first inverter 200A22 and the output current of second inverter 200B22 is avoided, and the control on first winding set 100a and second winding set 100b is normally performed.

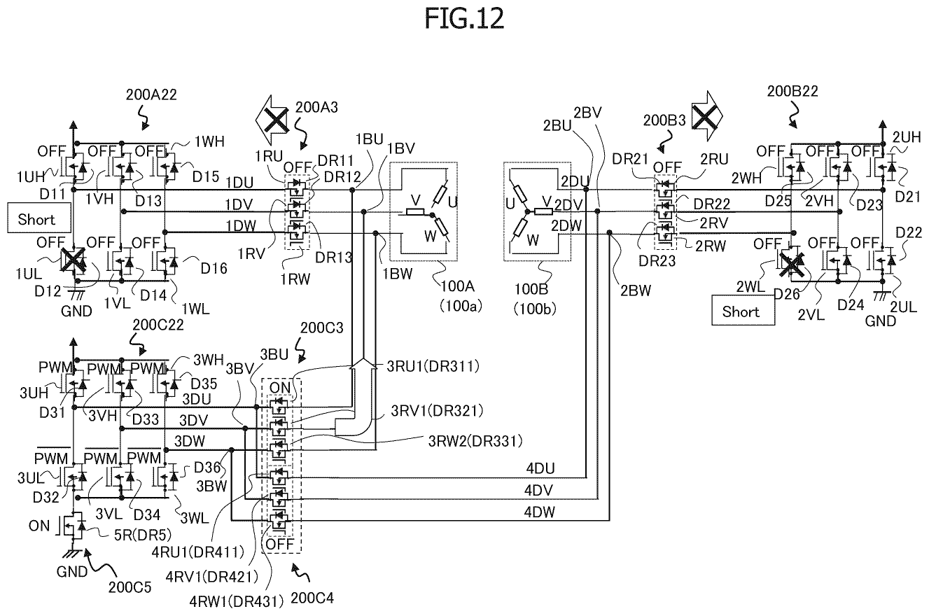

FIG. 12 illustrates a control state of each of the semiconductor switching elements when a short circuit failure occurs in semiconductor switching element 1UL of the lower arm of first inverter 200A22 and when a short circuit failure occurs in semiconductor switching element 2UL of the lower arm of second inverter 200B22 in the second embodiment.

Herein, AC power is supplied from third inverter 200C22, in place of first inverter 200A22 in which a failure has occurred, to first winding set 100a, and supply of AC power to second winding set 100b is stopped.

Specifically, each of the semiconductor switching elements is controlled, as will be described below.

When first inverter 200A22 is brought into a failure state due to the short circuit failure in semiconductor switching element 1UL and when second inverter 200B22 is brought into a failure state due to the short circuit failure in semiconductor switching element 2UL, the PWM control on first inverter 200A22 and second inverter 200B22 is stopped.

Each of semiconductor switching elements 1RU, 1RV, and 1RW constituting first relay 200A3 is switched from the ON-state to the OFF-state, and semiconductor switching elements 2RU, 2RV, and 2RW constituting second relay 200B3 are also switched from the ON-state to the OFF-state.

Each of semiconductor switching elements 3RU1, 3RV1, and 3RW1 constituting third relay 200C3 is switched from the OFF-state to the ON-state.

Each of semiconductor switching elements 4RU1, 4RV1, and 4RW1 constituting fourth relay 200C4 is held in the OFF-state.

Semiconductor switching element 5R constituting fifth relay 200C5 is switched from the OFF-state to the ON-state.

Then, the PWM control on respective semiconductor switching elements 3UH, 3UL, 3VH, 3VL, 3WH, and 3WL of third inverter 200C22 is started.

When each of the semiconductor switching elements is controlled as described above, AC power output from third inverter 200C22 is supplied to first winding set 100a even if a failure occurs in first inverter 200A22, whereby current supply to first winding set 100a is continued.

Each of semiconductor switching elements 1RU, 1RV, and 1RW constituting first relay 200A3 and semiconductor switching elements 2RU, 2RV, and 2RW constituting second relay 200B3 are switched to the OFF-state.

Parasitic diodes DR11, DR12, DR13, DR21, DR22, and DR23 have their cathodes located on the side of first winding set 100a or second winding set 100b and their anodes located on the side of first inverter 200A22 or second inverter 200B22.

Each of semiconductor switching elements 4RU1, 4RV1, and 4RW1 constituting fourth relay 200C4 is held in the OFF-state, and parasitic diodes DR411, DR421, and DR431 have their cathodes located on the side of third inverter 200C22 and their anodes located on the side of second winding set 100b.

Therefore, formation of a ground-fault circuit that goes through semiconductor switching element 1UL in which a short circuit failure has occurred and a ground-fault circuit that goes through semiconductor switching element 2UL in which a short circuit failure has occurred is avoided, whereby the control on first winding set 100a can be normally performed.

That is, first relay 200A3 functions as a cut-off relay that cuts off a ground-fault circuit that goes through semiconductor switching element 1UL in which a short circuit failure has occurred, and second relay 200B3 functions as a cut-off relay that cuts off a ground-fault circuit that goes through semiconductor switching element 2UL in which a short circuit failure has occurred.

Fourth relay 200C4 prevents the output current of third inverter 200C22 from flowing to the side of second winding set 100b.

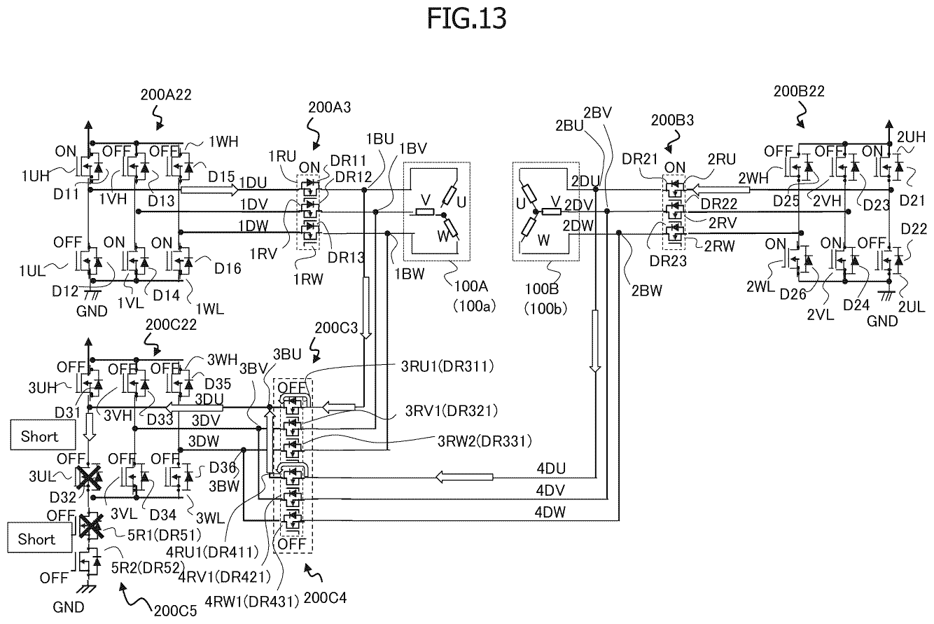

FIG. 13 illustrates a mode in which fifth relay 200C5 serving as a cut-off relay that cuts off a ground-fault path flowing into the ground GND of third inverter 200C22 is composed of a first semiconductor switching element 5R1 (a first cut-off relay) and a second semiconductor switching element 5R2 (a second cut-off relay) connected in series to first semiconductor switching element 5R1.

Herein, the orientation of a parasitic diode DR51 of first semiconductor switching element 5R1 and the orientation of a parasitic diode DR52 of second semiconductor switching element 5R2 are set such that their cathodes are located on the side of third inverter 200C22 and such that their anodes are located on the side of the ground GND.

That is, first semiconductor switching element 5R1 constituting fifth relay 200C5 has parasitic diode DR51 that passes the current in the direction from the ground GND toward third inverter 200C22.

Similarly, second semiconductor switching element 5R2 constituting fifth relay 200C5 has parasitic diode DR52 that passes the current in the direction from the ground GND toward third inverter 200C22.

First semiconductor switching element 5R1 and second semiconductor switching element 5R2 are connected in series to each other.

Herein, FIG. 13 illustrates a state in which a short circuit failure occurs in semiconductor switching element 3UL of the lower arm of third inverter 200C22 and in which a short circuit failure occurs in first semiconductor switching element 5R1 constituting fifth relay 200C5 when AC power is supplied from first inverter 200A22 to first winding set 100a and AC power is supplied from second inverter 200B22 to second winding set 100b.

At this time, formation of a ground-fault circuit that goes through semiconductor switching element 3UL and first semiconductor switching element 5R1 is prevented by second semiconductor switching element 5R2.

That is, even if a short circuit failure occurs in any of the semiconductor switching elements constituting the lower arm of third inverter 200C22 and even if a short circuit failure occurs in either one of the two semiconductor switching elements constituting fifth relay 200C5, that is, first semiconductor switching element 5R1 and second semiconductor switching element 5R2, a ground fault of the drive current of first winding set 100a and second winding set 100b is prevented.

Therefore, even if a short circuit failure occurs in third inverter 200C22 and even if a short circuit failure occurs in either one of the two semiconductor switching elements constituting fifth relay 200C5, first winding set 100a and second winding set 100b can be normally controlled, whereby fail-safe performance higher than when fifth relay 200C5 is composed of one semiconductor switching element can be exerted.

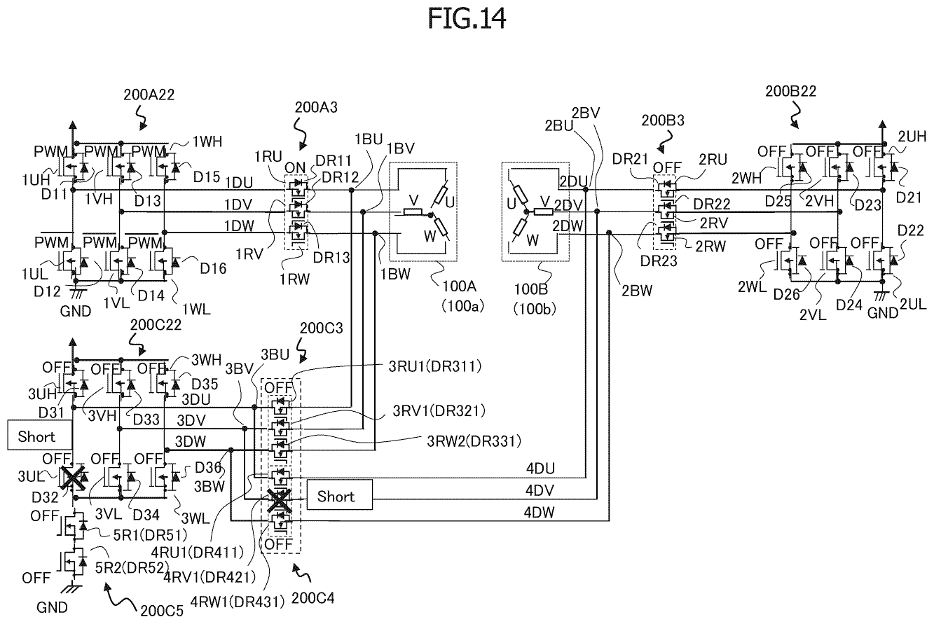

FIG. 14 illustrates a control state of the respective semiconductor switching elements when a short circuit failure occurs in semiconductor switching element 3UL of the lower arm of third inverter 200C22 and a short circuit failure occurs in semiconductor switching element 4RV1 of fourth relay 200C4 in the case in which fifth relay 200C5 is composed of first semiconductor switching element 5R1 and second semiconductor switching element 5R2.

Herein, supply of AC power from first inverter 200A22 to first winding set 100a is continued, while supply of AC power to second winding set 100b is stopped.

Specifically, the PWM control on second inverter 200B22 is stopped, and the PWM control on third inverter 200C22 is also held in the stopped state.

Second relay 200B3, third relay 200C3, fourth relay 200C4, and fifth relay 200C5 are controlled to be in the OFF-state.

AC power is supplied from first inverter 200A22 to first winding set 100a.

Herein, a ground fault of the output current of first inverter 200A22 through semiconductor switching element 3UL in which a short circuit failure has occurred is prevented by fifth relay 200C5 that functions as a cut-off relay.

Since second inverter 200B22 and second relay 200B3 are turned OFF and supply of AC power to second winding set 100b is stopped, the output current of first inverter 200A22 does not flow into second winding set 100b, nor does it produce a ground fault through semiconductor switching element 4RV1 in which a short circuit failure has occurred.

Therefore, even if a short circuit failure occurs in the lower arm of third inverter 200C22 and even if a short circuit failure occurs in fourth relay 200C4, the control on first winding set 100a can be normally performed.

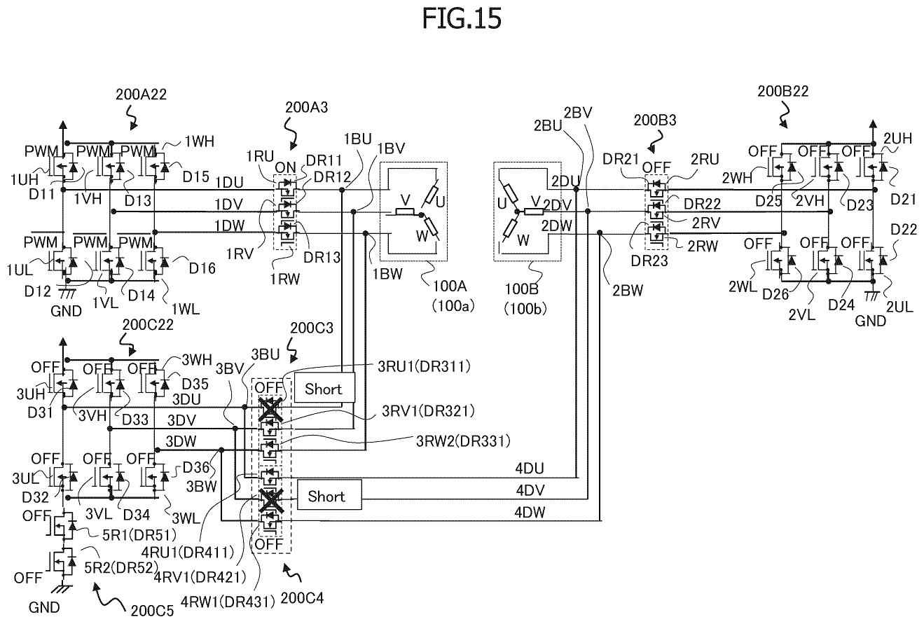

FIG. 15 illustrates a control state of each of the semiconductor switching elements when a short circuit failure occurs in semiconductor switching element 3RU1 of third relay 200C3 and semiconductor switching element 4RV1 of fourth relay 200C4.

In this case, supply of AC power from first inverter 200A22 to first winding set 100a is continued, while supply of AC power to second winding set 100b is stopped.

Specifically, the PWM control on second inverter 200B22 is stopped, and the PWM control on third inverter 200C22 is held in the stopped state.

Second relay 200B3, third relay 200C3, fourth relay 200C4, and fifth relay 200C5 are controlled to be in the OFF-state.

Supply of AC power from first inverter 200A22 to first winding set 100a is continued by continuing the PWM control on first inverter 200A22 and holding first relay 200A3 in the ON-state.

Herein, second inverter 200B22 and second relay 200B3 are turned OFF to stop supply of AC power to second winding set 100b.

Thus, the output current of first inverter 200A22 does not flow into second winding set 100b, nor does it produce a ground fault through semiconductor switching element 3RU1 in which a short circuit failure has occurred and semiconductor switching element 4RV1 in which a short circuit failure has occurred.

Therefore, even if a short circuit failure occurs in third relay 200C3 and fourth relay 200C4, the control on first winding set 100a can be normally performed.

### Third Embodiment

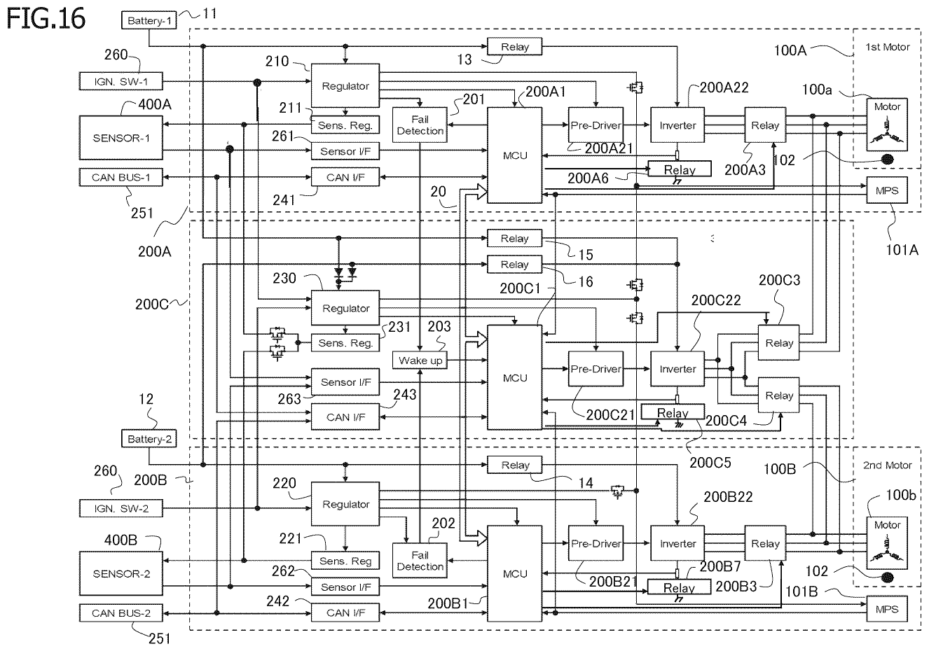

FIG. 16 is a block diagram illustrating a third embodiment of a detailed configuration of motor control device 200.

Motor control device 200 in FIG. 16 has a sixth relay 200A6 arranged between first inverter 200A22 and the ground GND.

Turning ON and OFF of sixth relay 200A6 is controlled by first MCU 200A1 of first control device 200A.

A seventh relay 200B7 is arranged between second inverter 200B22 and the ground GND.

Turning ON and OFF of seventh relay 200B7 is controlled by second MCU 200B1 of second control device 200B.

Motor control device 200 illustrated in FIG. 16 has the same configuration as motor control device 200 of the second embodiment illustrated in FIG. 7, except that sixth relay 200A6 and seventh relay 200B7 described above are added.

The elements in FIG. 16 that are the same as those in FIG. 7 are denoted by the same reference characters and detailed description thereof will thus be omitted.

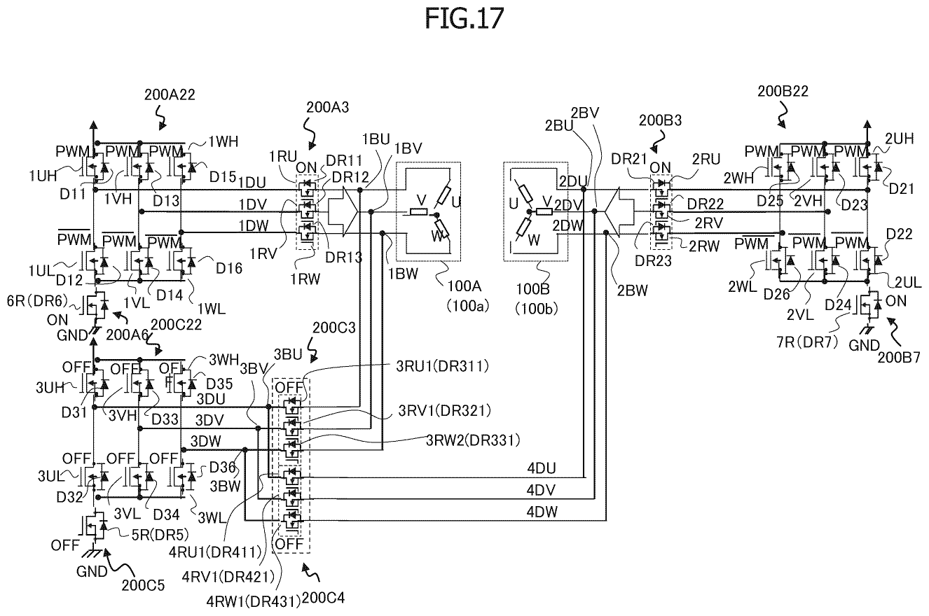

FIG. 17 is a circuit diagram illustrating a detailed configuration of inverters 200A22, 200B22, and 200C22 and relays 200A3, 200B3, 200C3, 200C4, 200C5, 200A6, and 200B7 illustrated in FIG. 16.

The elements in FIG. 17 that are the same as those in FIG. 8 are denoted by the same reference characters, and detailed description thereof will thus be omitted.

Sixth relay 200A6 is composed of a semiconductor switching element 6R arranged between first inverter 200A22 and the ground GND.

Herein, semiconductor switching element 6R constituting sixth relay 200A6 is an N-channel MOS-FET and is connected such that its drain terminal is located on the side of first inverter 200A22 and such that its source terminal is located on the side of the ground GND.

A parasitic diode DR6 of semiconductor switching element 6R is oriented such that its cathode is located on the side of first inverter 200A22 and such that its anode is located on the side of the ground GND.

That is, semiconductor switching element 6R constituting sixth relay 200A6 has parasitic diode DR6 that passes the current in the direction from the ground GND toward first inverter 200A22.

Seventh relay 200B7 is composed of a semiconductor switching element 7R arranged between second inverter 200B22 and the ground GND.

Herein, semiconductor switching element 7R constituting seventh relay 200B7 is an N-channel MOS-FET and is connected such that its drain terminal is located on the side of second inverter 200B22 and such that its source terminal is located on the side of the ground GND.

A parasitic diode DR7 of semiconductor switching element 7R is oriented such that its cathode is located on the side of second inverter 200B22 and such that its anode is located on the side of the ground GND.

That is, semiconductor switching element 7R constituting seventh relay 200B7 has parasitic diode DR7 that passes the current in the direction from the ground GND toward second inverter 200B22.

Sixth relay 200A6 is arranged between first branch points 1BU, 1BV, and 1BW and the ground GND of first inverter 200A22, has parasitic diode DR6 that passes the current in the direction from the ground GND of first inverter 200A22 toward first winding set 100a, and functions as a cut-off relay that cuts off a ground-fault path to the ground GND of first inverter 200A22.

Similarly, seventh relay 200B7 is arranged between second branch points 2BU, 2BV, and 2BW and the ground GND of second inverter 200B22, has parasitic diode DR7 that passes the current in the direction from the ground GND of second inverter 200B22 toward second winding set 100b, and functions as a cut-off relay that cuts off a ground-fault path to the ground GND of second inverter 200B22.

Sixth relay 200A6 can be configured by connecting two semiconductor switching elements 6R in series to each other. Similarly, seventh relay 200B7 can be configured by connecting two semiconductor switching elements 7R in series to each other.

Herein, two semiconductor switching elements 6R constituting sixth relay 200A6 are each arranged so as to have parasitic diode DR6 that passes the current in the direction from the ground GND of first inverter 200A22 toward first winding set 100a.

Similarly, two semiconductor switching elements 7R constituting seventh relay 200B7 are each arranged so as to have parasitic diode DR7 that passes the current in the direction from the ground GND of second inverter 200B22 toward second winding set 100b.

In other words, sixth relay 200A6 and seventh relay 200B7 can each include the first cut-off relay and the second cut-off relay connected in series to each other.

Parasitic diodes DR11, DR12, and DR13 of semiconductor switching elements 1RU, 1RV, and 1RW constituting first relay 200A3 illustrated in FIG. 17 are set so as to be oriented opposite to those of the first embodiment illustrated in FIG. 4 and the second embodiment illustrated in FIG. 8.

That is, semiconductor switching elements 1RU, 1RV, and 1RW constituting first relay 200A3 of FIG. 17 are arranged such that their drains are located on the side of first inverter 200A22 and such that their sources are located on the side of first winding set 100a, and parasitic diodes DR11, DR12, and DR13 are oriented such that their anodes are located on the side of first winding set 100a and such that their cathodes are located on the side of first inverter 200A22.

In other words, in the third embodiment, semiconductor switching elements 1RU, 1RV, and 1RW constituting first relay 200A3 have parasitic diodes DR11, DR12, and DR13 that pass the current in the direction from first winding set 100a toward first inverter 200A22.

Similarly, parasitic diodes DR21, DR22, and DR23 of semiconductor switching elements 2RU, 2RV, and 2RW constituting second relay 200B3 illustrated in FIG. 17 are set so as to be oriented opposite to those of the first embodiment illustrated in FIG. 4 and the second embodiment illustrated in FIG. 8.

That is, semiconductor switching elements 2RU, 2RV, and 2RW constituting second relay 200B3 of FIG. 17 are arranged such that their drains are located on the side of second inverter 200B22 and such that their sources are located on the side of second winding set 100b, and parasitic diodes DR21, DR22, and DR23 are oriented such that their anodes are located on the side of second winding set 100b and such that their cathodes are located on the side of second inverter 200B22.

In other words, in the third embodiment, semiconductor switching elements 2RU, 2RV, and 2RW constituting second relay 200B3 have parasitic diodes DR21, DR22, and DR23 that pass the current in the direction from second winding set 100b toward second inverter 200B22.

As will be specifically described later, sixth relay 200A6 and seventh relay 200B7 of FIG. 17 function as cut-off relays that cut off a ground-fault path to the ground GND of first inverter 200A22 and a ground-fault path to the ground GND of second inverter 200B22, respectively, in place of first relay 200A3 and second relay 200B3.

FIG. 17 illustrates a normal control state in which AC power is supplied from first inverter 200A22 to first winding set 100a and in which AC power is supplied from second inverter 200B22 to second winding set 100b.

In the normal control state, first inverter 200A22 and second inverter 200B22 are subjected to the PWM control, whereby sixth relay 200A6 and seventh relay 200B7 are held in the ON-state.

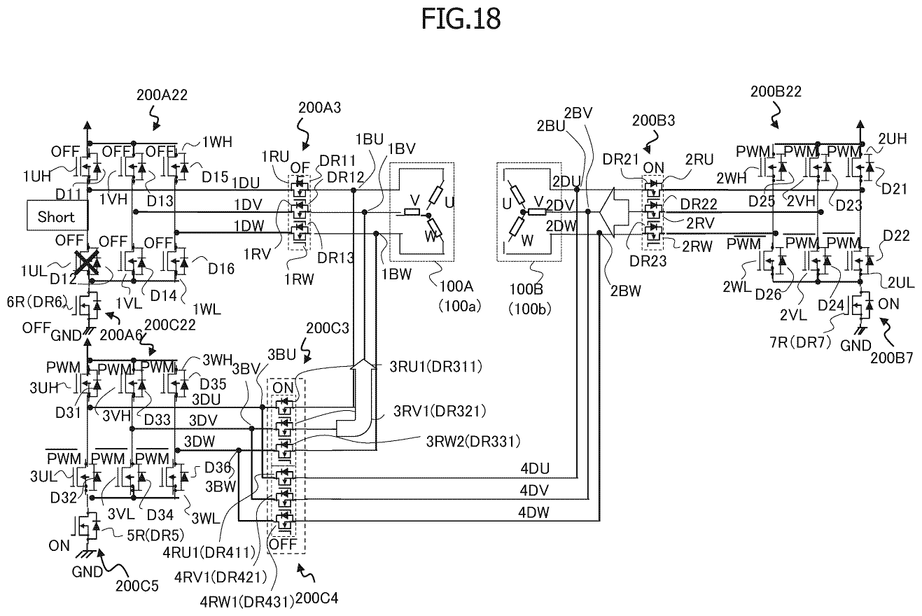

FIG. 18 illustrates a control state of each of the semiconductor switching elements constituting inverters 200A22, 200B22, and 200C22 and relays 200A3, 200B3, 200C3, 200C4, 200C5, 200A6, and 200B7 when a short circuit failure occurs in semiconductor switching element 1UL of the lower arm among semiconductor switching elements 1UH, 1UL, 1VH, 1VL, 1WH, and 1WL constituting first inverter 200A22 in the third embodiment.

Herein, AC power is supplied from third inverter 200C22, in place of first inverter 200A22 in which a failure has occurred, to first winding set 100a, and second inverter 200B22 normally supplies AC power to second winding set 100b.

Specifically, since a failure has occurred in first inverter 200A22, the PWM control on first inverter 200A22 is stopped, and each of semiconductor switching elements 1RU, 1RV, and 1RW constituting first relay 200A3 is switched from the ON-state to the OFF-state.

Semiconductor switching element 6R constituting sixth relay 200A6 is switched from the ON-state to the OFF-state.

In order to supply AC power from third inverter 200C22 to first winding set 100a, each of semiconductor switching elements 3UH, 3UL, 3VH, 3VL, 3WH, and 3WL constituting third inverter 200C22 is subjected to the PWM control.

Semiconductor switching elements 3RU1, 3RV1, and 3RW1 constituting third relay 200C3 are switched from the OFF-state to the ON-state, and semiconductor switching element 5R constituting fifth relay 200C5 is also switched from the OFF-state to the ON-state.

Semiconductor switching elements 4RU1, 4RV1, and 4RW1 constituting fourth relay 200C4 are held in the OFF-state.

In this control state, AC current is supplied from third inverter 200C22, in place of first inverter 200A22 in which a failure has occurred, to first winding set 100a.

Herein, even if each of semiconductor switching elements 1RU, 1RV, and 1RW constituting first relay 200A3 is switched to the OFF-state, parasitic diodes DR11, DR12, and DR13 pass the current flowing from first winding set 100a toward first inverter 200A22.

However, semiconductor switching element 6R constituting sixth relay 200A6 is controlled to be in the OFF-state, and parasitic diode DR6 of semiconductor switching element 6R is oriented such that its cathode is located on the side of first inverter 200A22 and such that its anode is located on the side of the ground GND.

That is, sixth relay 200A6 functions as a cut-off relay that cuts off a ground-fault path flowing from first inverter 200A22 to the ground GND by being controlled to be turned OFF.

Therefore, even if a short circuit failure occurs in semiconductor switching element 1UL constituting first inverter 200A22, a ground-fault circuit that goes through semiconductor switching element 1UL is not formed.

Thus, even if a short circuit failure occurs in the lower arm of first inverter 200A22, the control on first winding set 100a and second winding set 100b can be normally performed.

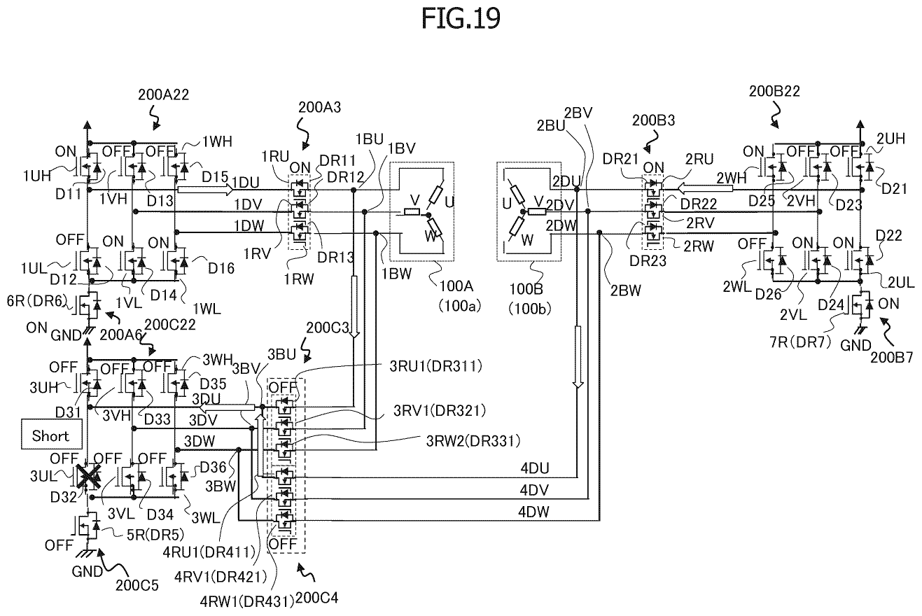

FIG. 19 illustrates that a ground-fault circuit that goes through semiconductor switching element 3UL is not formed even if a short circuit failure occurs in semiconductor switching element 3UL of the lower arm of third inverter 200C22 in the state in which first inverter 200A22 supplies AC power to first winding set 100a and in which second inverter 200B22 supplies AC power to second winding set 100b in the third embodiment.

In the state in which first inverter 200A22 supplies AC power to first winding set 100a and in which second inverter 200B22 supplies AC power to second winding set 100b, each of semiconductor switching elements 3RU1, 3RV1, and 3RW1 constituting third relay 200C3 and each of semiconductor switching elements 4RU1, 4RV1, and 4RW1 constituting fourth relay 200C4 are held in the OFF-state.

However, parasitic diodes DR311, DR321, DR331, DR411, DR421, and DR431 of respective semiconductor switching elements 3RU1, 3RV1, 3RW1, 4RU1, 4RV1, and 4RW1 have their cathodes located on the side of third inverter 200C22 and their anodes located on the side of motor 100.

Thus, the current supplied to first winding set 100a and second winding set 100b can pass through parasitic diodes DR311, DR321, DR331, DR411, DR421, and DR431 to flow into third inverter 200C22.

However, semiconductor switching element 5R constituting fifth relay 200C5 is held in the OFF-state, and parasitic diode DR5 of semiconductor switching element 5R is oriented such that its cathode is located on the side of third inverter 200C22 and such that its anode is located on the side of the ground GND.

Therefore, semiconductor switching element 5R (and parasitic diode DR5) functions as a cut-off relay that cuts off a ground-fault path, whereby a ground-fault circuit that goes through semiconductor switching element 3UL in which a short circuit failure has occurred is not formed.

Thus, even if a short circuit failure occurs in a semiconductor switching element of the lower arm of third inverter 200C22, a ground fault of the output current of first inverter 200A22 and the output current of second inverter 200B22 via the semiconductor switching element in which a short circuit failure has occurred is avoided.

Therefore, even if a short circuit failure occurs in a semiconductor switching element of the lower arm of third inverter 200C22, the control on first winding set 100a and second winding set 100b can be normally continued.

### Fourth Embodiment

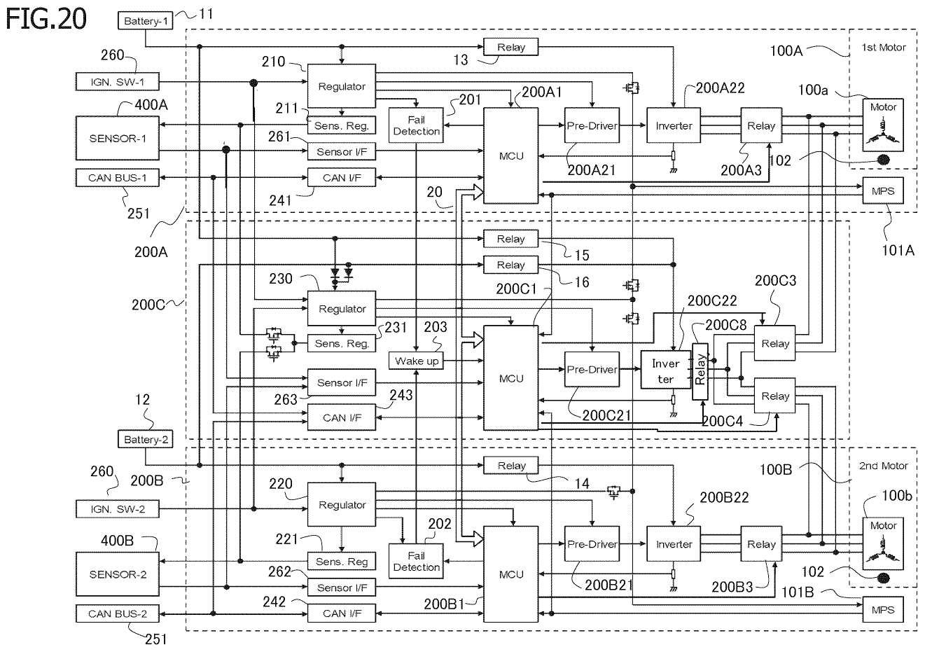

FIG. 20 is a block diagram illustrating a fourth embodiment of a detailed configuration of motor control device 200.

Motor control device 200 of FIG. 20 is different from motor control device 200 illustrated in FIG. 7 only in that fifth relay 200C5 is omitted and an eighth relay 200C8 is provided instead.

The elements in FIG. 20 that are the same as those in FIG. 7 are denoted by the same reference characters and detailed description thereof will thus be omitted.

Eighth relay 200C8 is arranged between third branch points 3BU, 3BV, and 3BW and third inverter 200C22, and turning ON and OFF of eighth relay 200C8 is controlled by third MCU 200C1 of third control device 200C.

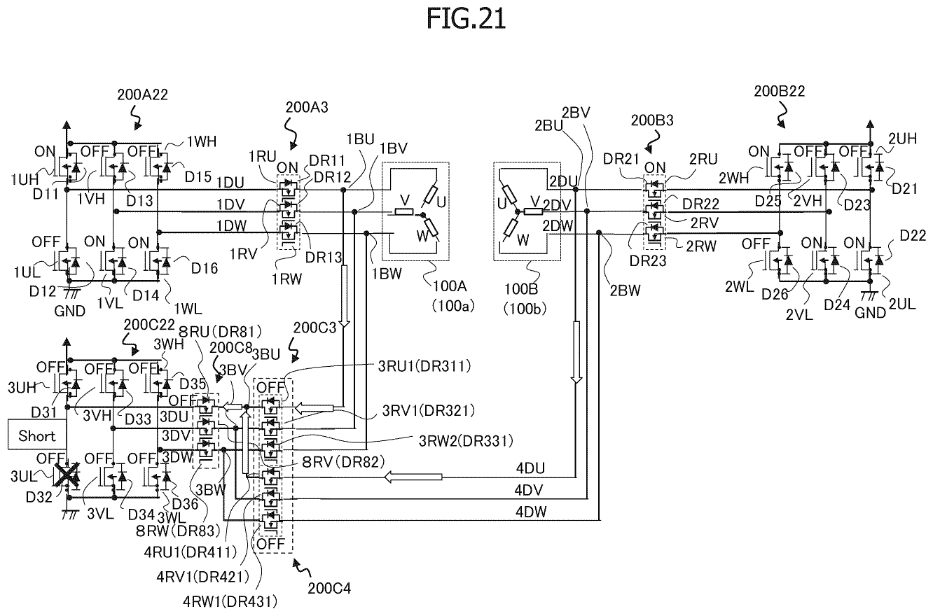

FIG. 21 is a circuit diagram illustrating a detailed configuration of inverters 200A22, 200B22, and 200C22 and relays 200A3, 200B3, 200C3, 200C4, and 200C8 illustrated in FIG. 20.

The elements in FIG. 21 that are the same as those in FIG. 8 are denoted by the same reference characters, and detailed description thereof will thus be omitted.

Eighth relay 200C8 is composed of semiconductor switching elements 8RU, 8RV, and 8RW respectively arranged on third drive lines 3DU, 3DV, and 3DW between first inverter 200A22 and third branch points 3BU, 3BV, and 3BW.

Semiconductor switching elements 8RU, 8RV, and 8RW are arranged such that their drains are respectively located on the side of third branch points 3BU, 3BV, and 3BW (on the side of motor 100) and such that their sources are located on the side of third inverter 200C22.

Parasitic diodes DR81, DR82, and DR83 of semiconductor switching elements 8RU, 8RV, and 8RW are oriented such that their cathodes are respectively located on the side of third branch points 3BU, 3BV, and 3BW and such that their anodes are located on the side of third inverter 200C22.

That is, semiconductor switching elements 8RU, 8RV, and 8RW constituting eighth relay 200C8 have parasitic diodes DR81, DR82, and DR83 that pass the current in the direction from third inverter 200C22 toward third branch points 3BU, 3BV, and 3BW, respectively.

Eighth relay 200C8 described above is provided as a cut-off relay in place of fifth relay 200C5 arranged between third inverter 200C22 and the ground GND in the second embodiment.

Eighth relay 200C8 has parasitic diodes DR81, DR82, and DR83 that pass the current in the direction from the ground GND of third inverter 200C22 toward first winding set 100a and second winding set 100b.

This configuration can avoid formation of a ground-fault circuit that goes through semiconductor switching element 3UL when a short circuit failure occurs in semiconductor switching element 3UL of the lower arm of third inverter 200C22 in the state in which first inverter 200A22 supplies AC power to first winding set 100a and in which second inverter 200B22 supplies AC power to second winding set 100b.

When the PWM control on third inverter 200C22 is stopped as illustrated in FIG. 21, semiconductor switching elements 3RU1, 3RV1, and 3RW1 constituting third relay 200C3, semiconductor switching elements 4RU1, 4RV1, and 4RW1 constituting fourth relay 200C4, and semiconductor switching elements 8RU, 8RV, and 8RW constituting eighth relay 200C8 are all held in the OFF-state.

Herein, the parasitic diodes of semiconductor switching elements 3RU1, 3RV1, and 3RW1 constituting third relay 200C3 and semiconductor switching elements 4RU1, 4RV1, and 4RW1 constituting fourth relay 200C4 may pass the current flowing toward third branch points 3BU, 3BV, and 3BW.

However, parasitic diodes DR81, DR82, and DR83 of semiconductor switching elements 8RU, 8RV, and 8RW constituting eighth relay 200C8 cut off the current flowing from third branch points 3BU, 3BV, and 3BW toward third inverter 200C22.

Therefore, even if a short circuit failure occurs in semiconductor switching element 3UL of the lower arm of third inverter 200C22, a ground fault of the output current of first inverter 200A22 and the output current of second inverter 200B22 through semiconductor switching element 3UL is prevented by eighth relay 200C8.

Thus, even if a short circuit failure occurs in semiconductor switching element 3UL of the lower arm of third inverter 200C22, the control on first winding set 100a and second winding set 100b can be normally performed.

### “Motor Control Procedure”

Hereinafter, a mode of a control procedure for motor 100 performed by aforementioned motor control device 200 will be described.

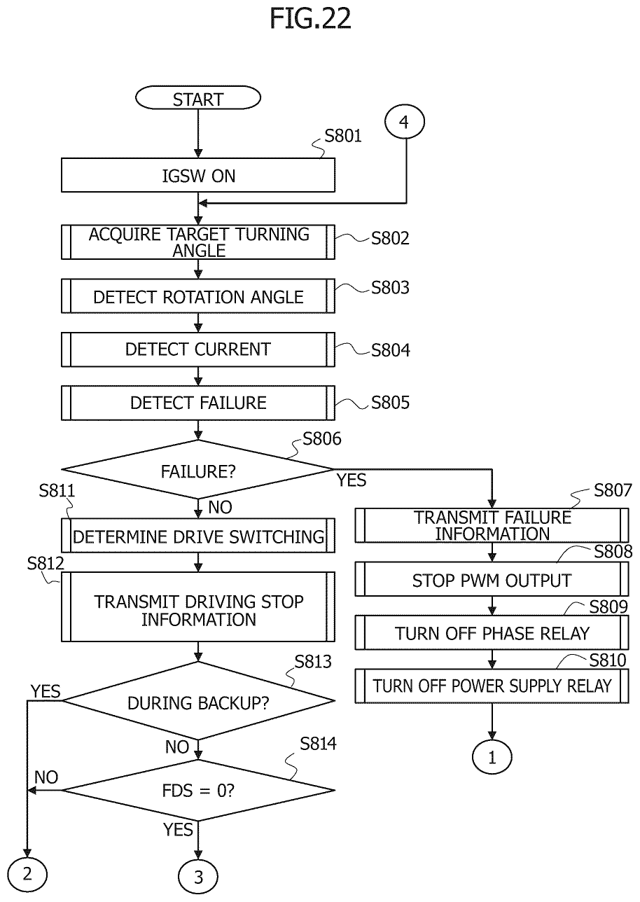

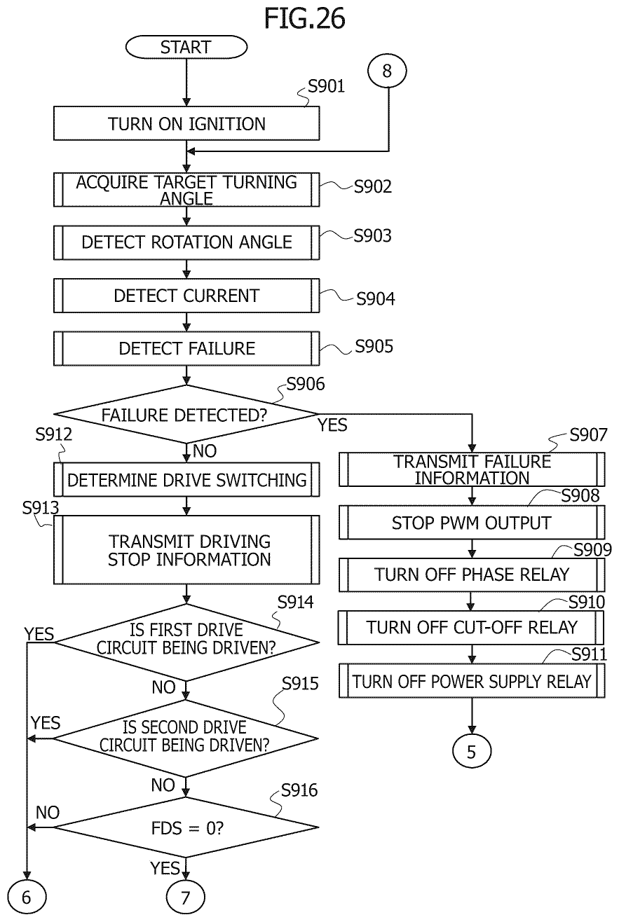

The flowcharts in FIG. 22 to FIG. 25 illustrate control procedures carried out by first control device 200A (first MCU 200A1) and second control device 200B (second MCU 200B1). The flowcharts in FIG. 26 to FIG. 29 illustrate control procedures carried out by third control device 200C (third MCU 200C1).

The control procedures illustrated in the flowcharts in FIG. 22 to FIG. 29 include processing of supplying AC power to first winding set 100a and second winding set 100b by one of normal drive circuits when a failure occurs in first drive circuit 200A2 or second drive circuit 200B2 (hereinafter also referred to as failure-state drive processing).

In the failure-state drive processing, processing of switching the drive circuit that supplies AC power to first winding set 100a and second winding set 100b (hereinafter also referred to as drive switching processing) is carried out.

The drive switching processing described above can prevent the semiconductor switching elements constituting the inverters from rising in temperature while continuing driving of motor 100, thereby protecting the semiconductor switching elements.

The control procedures illustrated in the flowcharts in FIG. 22 to FIG. 25 are control procedures common to each of first control device 200A and second control device 200B.

Thus, the control procedures carried out by first control device 200A will be described below as a representative example, and description of the control procedures carried out by second control device 200B will be omitted.

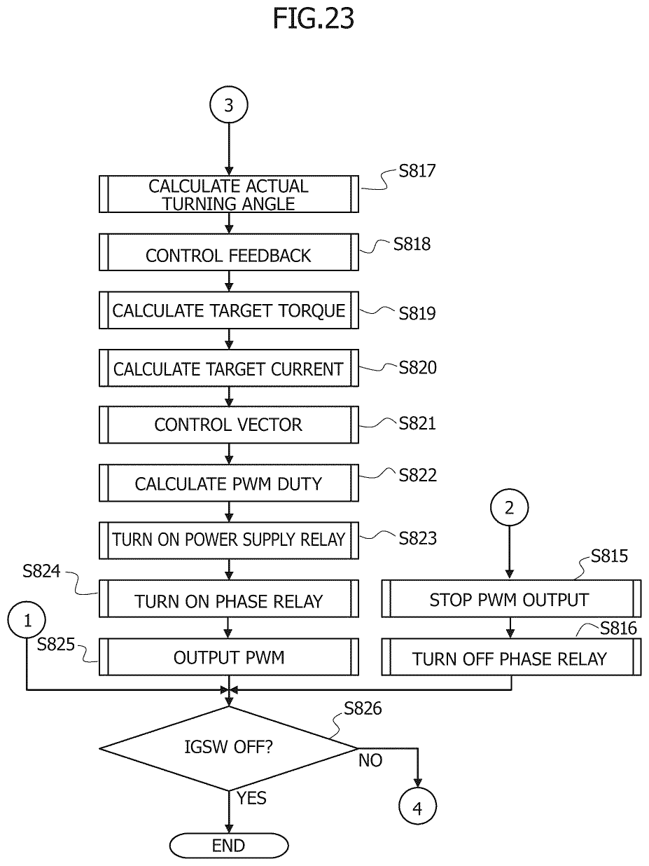

The flowcharts in FIG. 22 and FIG. 23 illustrate a main routine of the control procedure performed by first control device 200A.

In step S801, first control device 200A (first MCU 200A1) is started by turning ON of ignition switch 260, which is a main switch for driving and stopping vehicle 1. In next step S802, information about a target turning angle of front wheels 2L and 2R is acquired.

In step S803, first control device 200A acquires an output signal of motor rotation angle sensor 101 and calculates a rotation angle of motor 100 based on the acquired output signal.

In step S804, first control device 200A calculates a drive current of motor 100 based on an output of a current sensor, illustration of which is omitted.

Next, in step S805, first control device 200A diagnoses presence or absence of a failure in a drive system of first winding set 100a including first drive circuit 200A2.

The failure mode includes a short circuit failure in a semiconductor switching element constituting first inverter 200A22, and the like.

Next, in step S806, first control device 200A determines whether an occurrence of a failure has been detected.

Herein, when detecting the occurrence of a failure, first control device 200A transitions from step S806 to step S807.

In step S807, first control device 200A transmits information indicating that supply of AC power from first inverter 200A22 to first winding set 100a is stopped due to the occurrence of a failure, to the other systems (second control device 200A and third control device 200C).

Next, in step S808, first control device 200A stops the PWM control on first inverter 200A22.

In step S809, first control device 200A controls all of semiconductor switching elements 1RU, 1RV, and 1RW constituting first relay 200A3 (in other words, the phase relay of first winding set 100a) to be turned OFF.

In the case of motor control device 200 of the third embodiment provided with sixth relay 200A6 and seventh relay 200B7, first control device 200A also controls sixth relay 200A6 to be turned OFF when controlling first relay 200A3 to be turned OFF in step S809.

After controlling first relay 200A3 to be turned OFF in step S809, first control device 200A, in step S810, controls a power supply relay 13, which disconnects and connects a power supply path from first battery 11 to first inverter 200A22, to be turned OFF.

When the drive system of first winding set 100a is normal, first control device 200A transitions from step S806 to step S811.

In step S811, first control device 200A determines presence or absence of a request for switching the drive circuit for the drive switching processing.

As will be described later specifically, first control device 200A determines presence or absence of the request for switching the drive circuit based on an accumulated driving time of first inverter 200A22, an estimated temperature of the semiconductor switching elements constituting first inverter 200A22, or the like.

When determining that the request for switching the drive circuit has occurred, first control device 200A raises a drive switching determination flag FDS to 1 and stores information about the request for carrying out the drive switching processing.

Next, in step S812, first control device 200A transmits driving stop information (in other words, information about the drive switching determination) based on the request for switching the drive circuit, to the other systems.

In step S813, first control device 200A determines whether driving is being performed by third inverter 200C22 for backup.

When driving is being performed by third inverter 200C22, first control device 200A transitions to step S815 and stops the PWM control on first inverter 200A22.

In step S816, first control device 200A controls all of semiconductor switching elements 1RU, 1RV, and 1RW constituting first relay 200A3, which is the phase relay of first winding set 100a, to be turned OFF.

When driving is not being performed by third inverter 200C22, first control device 200A transitions from S813 to step S814 and determines whether the drive switching determination flag FDS is set at 0.

The drive switching determination flag FDS is a flag indicating whether an inverter switching command has been set. The drive switching determination flag FDS=1 indicates a state in which switching of the inverter that supplies AC power to motor 100 is commanded, in other words, a state in which a drive switching request has been set.

Herein, when in the state in which the drive switching determination flag is set at 1 and in which switching of the inverter that supplies AC power to motor 100 has been commanded, first control device 200A transitions to step S815.

Next, in step S815, first control device 200A stops the PWM control on first inverter 200A22, and in step S816, controls all of semiconductor switching elements 1RU, 1RV, and 1RW constituting first relay 200A3 to be turned OFF.

When not in the state in which motor 100 is being driven by third inverter 200C22 and when in the state in which the drive switching determination flag is set at 0 and in which the request for switching the inverter has not been set, first control device 200A transitions to step S817 and subsequent steps. First inverter 200A22 is subjected to the PWM control, whereby AC power is supplied from first inverter 200A22 to motor 100.

In step S817, first control device 200A calculates the turning angle of front wheels 2L and 2R based on the output signal of turning angle detection device 400.

Next, in step S818, first control device 200A compares an actual turning angle with a target turning angle by feed back the turning angle of front wheels 2L and 2R calculated based on the output signal of turning angle detection device 400 to a target value side.

In step S819, first control device 200A calculates a target motor torque for bringing the actual turning angle closer to the target turning angle based on a control deviation which is a difference between the actual turning angle and the target turning angle.

In step S820, first control device 200A calculates a d-axis current command value and a q-axis current command value according to the target motor torque.

Next, in step S821, first control device 200A carries out vector control.

Specifically, first control device 200A carries out three-phase to two-phase transformation of transforming actual currents Iu, Iv, and Iw in the three phases into a d-axis actual current and a q-axis actual current, and calculates a d-axis voltage command value Vd and a q-axis voltage command value Vq based on a deviation between the d-axis current command value and the q-axis current command value according to the target motor torque and the d-axis actual current and the q-axis actual current.

Next, in step S822, first control device 200A transforms the d-axis voltage command value Vd and the q-axis voltage command value Vq into three-phase command voltages Vu, Vv, and Vw based on the rotation angle of motor 100, and calculates a duty ratio of the PWM control based on the three-phase command voltages Vu, Vv, and Vw.

Next, in step S823, first control device 200A turns on power supply relay 13.

In step S824, first control device 200A controls all of semiconductor switching elements 1RU, 1RV, and 1RW constituting first relay 200A3, which is a phase relay, to be turned ON.

Next, in step S825, first control device 200A outputs a control pulse for controlling turning ON and OFF of each of the semiconductor switching elements of first inverter 200A22 to first pre-driver 200A21 through PWM based on the three-phase command voltages Vu, Vv, and Vw.

After processing in each of step S810, step S816, and step S825, first control device 200A transitions to step S826 and determines whether ignition switch 260 has been switched from ON to OFF.

If ignition switch 260 is held in the ON-state, first control device 200A returns to step S802 and repeats the control processing in step S802 to step S825.

When ignition switch 260 is switched from ON to OFF, first control device 200A terminates the control processing in aforementioned step S802 to step S825.

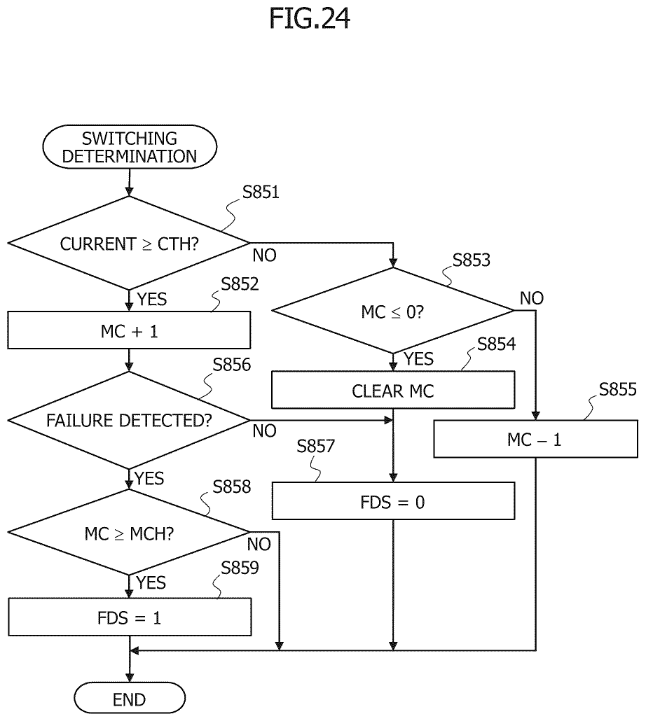

FIG. 24 is a flowchart illustrating details of processing content in step S811, that is, a subroutine of processing of determining presence or absence of the request for switching the drive circuit.

The determination processing illustrated in the flowchart of FIG. 24 illustrates, as a mode, drive switching determination based on an accumulated driving time.

First, in step S851, first control device 200A determines whether the output current of first inverter 200A22 is greater than or equal to a predetermined value CTH.

In other words, in step S851, first control device 200A determines whether it is the state in which AC power is supplied from first inverter 200A22 to first winding set 100a and whether it is under a condition that the semiconductor switching elements of first inverter 200A22 generate heat.

Herein, when determining that the output current of first inverter 200A22 is greater than or equal to the predetermined value CTH, first control device 200A transitions to step S852 and carries out update processing of incrementing the present value of a measurement counter MC for measuring an accumulated driving time of first inverter 200A22 by 1.

When determining that the output current of first inverter 200A22 is less than the predetermined value CTH, first control device 200A transitions to step S853 and determines whether the measurement counter MC is less than or equal to 0.

When the measurement counter MC is less than or equal to 0, first control device 200A resets the measurement counter MC at 0 in step S854.

When the measurement counter MC is greater than 0, first control device 200A, in step S855, carries out update processing of subtracting 1 from the present value of the measurement counter MC.

That is, when the output current of first inverter 200A22 is greater than or equal to the predetermined value CTH, the measurement counter MC is incremented by 1 for each execution cycle of the present subroutine.

When the output current of first inverter 200A22 is less than the predetermined value CTH, the measurement counter MC is decremented by 1 for each execution cycle of the present subroutine with the lower limit set at 0.

Therefore, the value of the measurement counter MC indicates an accumulated time in the state in which the output current of first inverter 200A22 is greater than or equal to the predetermined value CTH, in other words, an accumulated driving time which is an integrated value of time periods of driving performed by first inverter 200A22.

After carrying out the update processing of incrementing the present value of the measurement counter MC by 1 in step S852, first control device 200A transitions to step S856.

In step S856, first control device 200A determines whether a failure has been detected in second control device 200B or third control device 200C, which are the other systems, based on failure information acquired from second control device 200B or third control device 200C.

When a failure has not been detected in second control device 200B and third control device 200C, first control device 200A transitions to step S857 and stores information indicating that it is in a state in which the request for switching the inverter (drive circuit) has not yet occurred by resetting the drive switching determination flag FDS at 0.

That is, when first control device 200A, second control device 200B, and third control device 200C are all normal, the state in which AC power is supplied from first inverter 200A22 to first winding set 100a and in which AC power is supplied from second inverter 200B22 to second winding set 100b is held.

After resetting the measurement counter MC at 0 in step S854, first control device 200A also transitions to step S857 and resets the drive switching determination flag FDS at 0.

That is, when the measurement counter MC is reset at 0, first control device 200A determines that the accumulated driving time of first inverter 200A22 is short and currently there is no need to switch the inverter (drive circuit), and resets the drive switching determination flag FDS at 0.

When determining that a failure has been detected in second control device 200B or third control device 200C in step S856, first control device 200A transitions to step S858 and determines whether the measurement counter MC is greater than or equal to a predetermined value MCH.

When the measurement counter MC is greater than or equal to the predetermined value MCH (in other words, when the accumulated driving time of first inverter 200A22 is greater than or equal to a set time), first control device 200A transitions to step S859 and sets the drive switching determination flag FDS at 1, thereby storing information indicating that it is in the state in which the request for switching the inverter (drive circuit) has occurred.

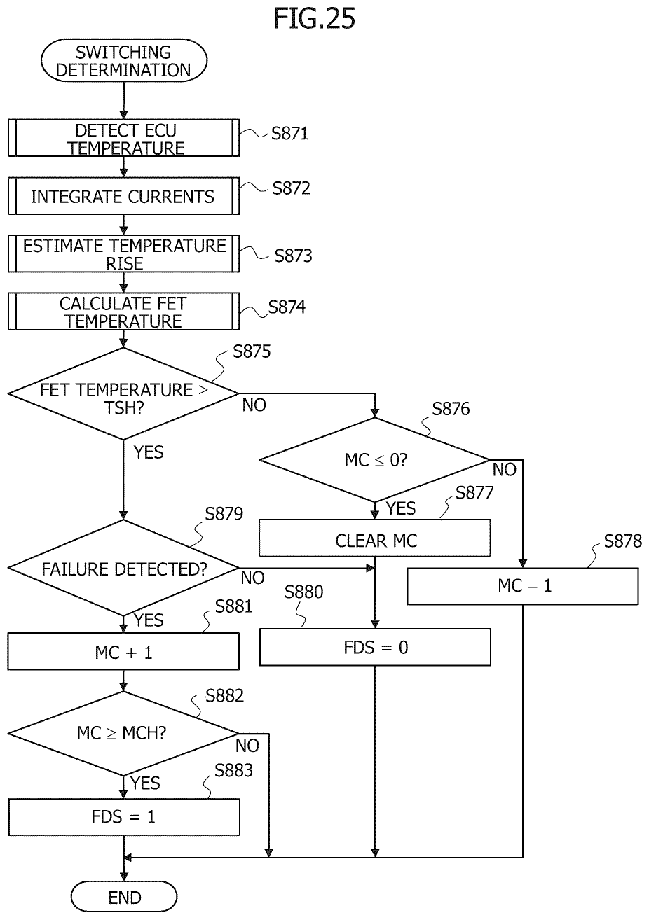

The flowchart of FIG. 25 is another mode of the processing of determining presence or absence of the request for switching the drive circuit.

Herein, first control device 200A estimates the temperature of the semiconductor switching elements (MOS-FETs) constituting first inverter 200A22, and carries out the drive switching determination based on a temperature estimated value of the semiconductor switching elements.

In step S871, first control device 200A detects the temperature of first control device 200A (specifically, a circuit board temperature of a portion on which first control device 200A is mounted) based on an output signal of a temperature sensor, illustration of which is omitted.

In next step S872, first control device 200A carries out processing of integrating current values of the drive current output from first inverter 200A22.

Next, in step S873, first control device 200A estimates a temperature rise in the semiconductor switching elements (MOS-FETs) constituting first inverter 200A22 based on an integrated current value.

In next step S874, first control device 200A calculates the temperature (FET estimated temperature) of the semiconductor switching elements constituting first inverter 200A22.

Specifically, first control device 200A adds a temperature rise estimated value calculated in step S873 to the temperature of first control device 200A detected in step S871 and estimates the temperature of the semiconductor switching elements constituting first inverter 200A22.

Next, in step S875, first control device 200A determines whether the estimated temperature of the semiconductor switching elements constituting first inverter 200A22 is greater than or equal to a predetermined value TSH.

When the estimated temperature of the semiconductor switching elements constituting first inverter 200A22 is less than the predetermined value TSH, first control device 200A transitions to step S876 and determines whether the value of the measurement counter MC is less than or equal to 0.

When the value of the measurement counter MC is less than or equal to 0, first control device 200A resets the measurement counter MC at 0 in step S877.

When the value of the measurement counter MC is greater than 0, first control device 200A, in step S878, carries out the update processing of subtracting 1 from the present value of the measurement counter MC.

When the estimated temperature of the semiconductor switching elements constituting first inverter 200A22 is greater than or equal to the predetermined value TSH, first control device 200A, in step S879, determines whether a failure has been detected in second control device 200B or third control device 200C, which are the other systems, based on failure information acquired from second control device 200B and third control device 200C.

Herein, when a failure has not been detected in the other systems, first control device 200A transitions to step S880 and resets the drive switching determination flag FDS at 0.

After resetting the measurement counter MC at 0 in step S877, first control device 200A also transitions to step S880 and resets the drive switching determination flag FDS at 0.

When determining that a failure has been detected in the other systems in step S879, first control device 200A transitions to step S881 and carries out the update processing of incrementing the present value of the measurement counter MC by 1.

Next, in step S882, first control device 200A determines whether the measurement counter MC is greater than or equal to the predetermined value MCH.

When the measurement counter MC is greater than or equal to the predetermined value MCH, first control device 200A transitions to step S883 and sets the drive switching determination flag FDS at 1, thereby storing information indicating that it is in the state in which the request for switching the inverter (drive circuit) has occurred.

When the measurement counter MC is less than the predetermined value MCH, first control device 200A directly terminates the present subroutine.

FIG. 26 is a flowchart illustrating a main routine of the control procedure performed by third control device 200C (third MCU 200C1).

The content of processing in each of step S901 to step S906 in the flowchart of FIG. 26 is similar to that of step S801 to step S806 in the flowchart of FIG. 22, and detailed description thereof will thus be omitted.

When a failure is detected in step S906, third control device 200C transitions to step S907 and transmits information indicating that a failure has occurred in third control device 200C and that supply of AC power from third inverter 200C22 is stopped, to first control device 200A and second control device 200B, which are the other systems.

Next, in step S908, third control device 200C stops the PWM control on third inverter 200C22.

In next step S909, third control device 200C controls third relay 200C3 (first switching relay) and fourth relay 200C4 (second switching relay) to be turned OFF.

In step S910, third control device 200C controls the cut-off relay for cutting off a ground-fault path and flowing of the drive current to be turned OFF.

For example, in the case of the first embodiment, the cut-off relays controlled to be turned OFF by third control device 200C in step S910 are semiconductor switching elements 3RU2, 3RV2, and 3RW2 constituting third relay 200C3 and semiconductor switching elements 4RU2, 4RV2, and 4RW2 constituting fourth relay 200C4.

That is, in the case of the first embodiment, third relay 200C3 and fourth relay 200C4 each have the function as the cut-off relay along with the function as the switching relay.

In the case of the second embodiment and the third embodiment, the cut-off relay controlled to be turned OFF by third control device 200C in step S910 is fifth relay 200C5 (semiconductor switching element 5R).

In the case of the fourth embodiment, the cut-off relay controlled to be turned OFF by third control device 200C in step S910 is eighth relay 200C8 (semiconductor switching elements 8RU, 8RV, and 8RW).

After controlling the cut-off relay to be turned OFF in step S910, third control device 200C, in step S911, controls power supply relay 15 and power supply relay 16 to be turned OFF. When determining that a failure has not occurred in step S906, third control device 200C transitions to step S912 and performs the drive switching determination.

The drive switching determination carried out in step S912 described above will be specifically described later.

Next, in step S913, third control device 200C transmits information about driving and stopping of third drive circuit 200C2 (third inverter 200C22) to first control device 200A and second control device 200B.

In step S914, third control device 200C determines whether first drive circuit 200A2 (first inverter 200A22) is being driven based on the information transmitted from first control device 200A.

Herein, when first drive circuit 200A2 (first inverter 200A22) is not being driven, third control device 200C transitions to step S915 and determines whether second drive circuit 200B2 (second inverter 200B22) is being driven based on the information transmitted from second control device 200B.

When at least one of first drive circuit 200A2 and second drive circuit 200B2 is being driven, third control device 200C, in steps S917 to S919, carries out processing similar to that of step S908 to step S910, thereby stopping driving of third drive circuit 200C2.

When driving of first drive circuit 200A2 and second drive circuit 200B2 is stopped, third control device 200C transitions to step S916 and determines whether the drive switching determination flag FDS is 0.

Herein, if the drive switching determination flag FDS is 1 and if a request for switching driving performed by third drive circuit 200C2 (third inverter 200C22) to driving performed by another system has occurred, third control device 200C carries out processing in step S917 to step S919, thereby stopping the driving performed by third drive circuit 200C2 (third inverter 200C22).

If the drive switching determination flag FDS is 0 and if the request for switching the driving performed by third drive circuit 200C2 (third inverter 200C22) to driving performed by another system has not occurred, third control device 200C carries out each processing in step S920 to step S929.

In each of step S920 to step S926 among step S920 to step S929, third control device 200C executes processing similar to that of step S817 to step S823 in the flowchart of aforementioned FIG. 23, and detailed description thereof in this embodiment will thus be omitted.

In step S927, third control device 200C controls third relay 200C3 and fourth relay 200C4, which correspond to phase relays in the driving performed by third inverter 200C22, to be turned ON.

In next step S928, third control device 200C controls the cut-off relay targeted for turning-OFF control in aforementioned step S910 to be turned ON.

In next step S929, third control device 200C outputs a control pulse for controlling turning ON and OFF of each of the semiconductor switching elements of third inverter 200C22 to third pre-driver 200C21 through PWM based on the three-phase command voltages Vu, Vv, and Vw.

After processing in each of step S911, step S919, and step S929, third control device 200C transitions to step S930 and determines whether ignition switch 260 has been switched from ON to OFF.

When ignition switch 260 is held in the ON-state, third control device 200C returns to step S902 and repeats the control processing from step S902 to step S929.

When ignition switch 260 is switched from ON to OFF, third control device 200C terminates the control processing in aforementioned step S902 to step S929.

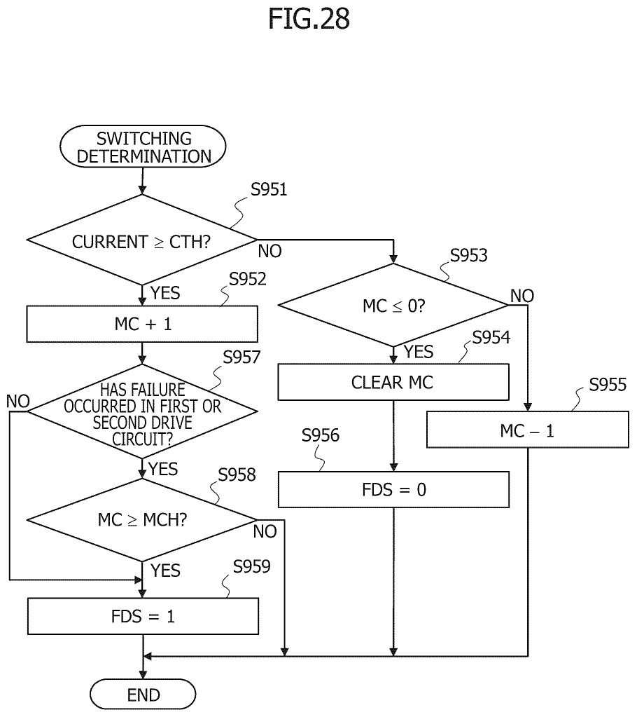

FIG. 28 is a flowchart illustrating details of processing content in step S912 in the flowchart of FIG. 26, that is, a subroutine of the drive switching determination.

The flowchart of FIG. 28 illustrates drive switching determination based on an accumulated driving time as a mode of the drive switching determination.

First, in step S951, third control device 200C determines whether the output current of third inverter 200C22 is greater than or equal to the predetermined value CTH.

Herein, when determining that the output current of third inverter 200C22 is greater than or equal to the predetermined value CTH, third control device 200C transitions to step S952 and carries out the update processing of incrementing the present value of the measurement counter MC for measuring the accumulated driving time of third inverter 200C22 by 1.

When determining that the output current of third inverter 200C22 is less than the predetermined value CTH, third control device 200C transitions to step S953 and determines whether the measurement counter MC is less than or equal to 0.

When the measurement counter MC is less than or equal to 0, third control device 200C, in step S954, resets the measurement counter MC at 0, and thereafter, in step S956, resets the drive switching determination flag FDS at 0.

When the measurement counter MC is greater than 0, third control device 200C, in step S955, carries out the update processing of subtracting 1 from the present value of the measurement counter MC.

After carrying out the update processing of incrementing the present value of the measurement counter MC by 1 in step S952, third control device 200C transitions to step S957. In step S957, third control device 200C determines whether a failure in either one of first drive circuit 200A2 and second drive circuit 200B2 has been detected.

When a failure in either one of first drive circuit 200A2 and second drive circuit 200B2 has been detected, that is, when normal drive systems include two systems including third drive circuit 200C2 and when the drive system that supplies AC power to first winding set 100a and second winding set 100b can be switched, third control device 200C transitions to step S958.

In step S958, third control device 200C determines whether the measurement counter MC is greater than or equal to the predetermined value MCH.

When the measurement counter MC is greater than or equal to the predetermined value MCH, third control device 200C transitions to step S959 and sets the drive switching determination flag FDS at 1, thereby storing information indicating that it is in the state in which the request for switching the inverter (drive circuit) has occurred.

When the measurement counter MC is less than the predetermined value MCH, third control device 200C terminates the present subroutine without carrying out the processing of setting the drive switching determination flag FDS.

When determining in step S957 that it is not the state in which a failure has occurred in either one of first drive circuit 200A2 and second drive circuit 200B2, that is, when determining that first drive circuit 200A2 and second drive circuit 200B2 are both normal or that a failure has occurred both in first drive circuit 200A2 and second drive circuit 200B2, third control device 200C transitions to step S959 and sets the drive switching determination flag FDS at 1.

Accordingly, even if the request for switching driving performed by third drive circuit 200C2 occurs when a failure occurs in first drive circuit 200A2 and second drive circuit 200B2 and when first drive circuit 200A2 and second drive circuit 200B2 are in the driving stopped state, the drive switching determination flag FDS is immediately set at 1 because there is no normal drive circuit that drives motor 100 in place of third drive circuit 200C2.

If first drive circuit 200A2 and second drive circuit 200B2 are normal, the drive switching determination flag FDS is immediately set at 1 because a return should only be made to the basic state in which first drive circuit 200A2 drives first inverter 200A22 and second drive circuit 200B2 drives second inverter 200B22.

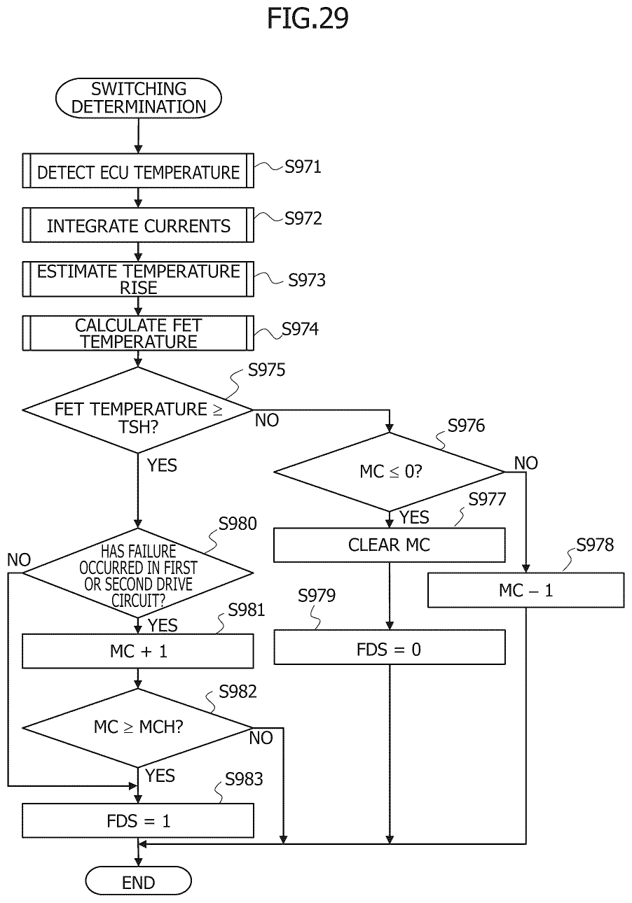

The flowchart of FIG. 29 illustrates another mode of the drive switching determination in step S912 in the flowchart of FIG. 26.

Herein, third control device 200C estimates the temperature of the semiconductor switching elements (MOS-FETs) constituting third inverter 200C22, and carries out the drive switching determination based on an estimated temperature value of the semiconductor switching elements.

Processing in each of step S971 to step S979 in FIG. 29 is equivalent in processing content to step S871 to step S878 and step S880 in FIG. 25 although they differ in that processing is performed by third control device 200C and the semiconductor switching elements constituting third inverter 200C22 are targeted for temperature estimation.

Thus, detailed description of processing content in each of step S971 to step S979 will be omitted.

When determining that the estimated temperature of the semiconductor switching elements constituting third inverter 200C22 is greater than or equal to the predetermined value TSH in step S975, third control device 200C transitions to step S980.

In step S980, third control device 200C determines whether a failure in either one of first drive circuit 200A2 and second drive circuit 200B2 has been detected.

When a failure in either one of first drive circuit 200A2 and second drive circuit 200B2 has been detected, that is, when normal drive systems include two systems including third drive circuit 200C2 and when the drive system that supplies AC power to first winding set 100a and second winding set 100b can be switched, third control device 200C transitions to step S981.

In step S981, third control device 200C carries out the update processing incrementing the present value of the measurement counter MC by 1.

Thereafter, third control device 200C transitions to step S982 and determines whether the measurement counter MC is greater than or equal to the predetermined value MCH.

When the measurement counter MC is greater than or equal to the predetermined value MCH, third control device 200C transitions to step S983 and sets the drive switching determination flag FDS at 1, thereby storing information indicating that it is in the state in which the request for switching the inverter (drive circuit) has occurred.

When the measurement counter MC is less than the predetermined value MCH, third control device 200C directly terminates the present subroutine without carrying out the processing of setting the drive switching determination flag FDS.

When determining in step S980 that it is not the state in which a failure has occurred in either one of first drive circuit 200A2 and second drive circuit 200B2, that is, when determining that first drive circuit 200A2 and second drive circuit 200B2 are both normal or that a failure has occurred both in first drive circuit 200A2 and second drive circuit 200B2, third control device 200C transitions to step S983 and sets the drive switching determination flag FDS at 1.

Hereinafter, a control state of the relays and the inverters when the control procedures illustrated in the flowcharts in FIG. 22 to FIG. 29 are executed will be described for motor control device 200 of each of the first to fourth embodiments.

In motor control device 200 of the second embodiment, for example, when a state in which the accumulated driving time of second inverter 200B22 exceeds the set time or the FET estimated temperature of second inverter 200B22 exceeds the set temperature continues in a state in which a failure occurs in first inverter 200A22 and in which AC power is supplied from second inverter 200B22 to first winding set 100a and second winding set 100b as illustrated in FIG. 9, second control device 200B raises the drive switching determination flag FDS to 1.

When the drive switching determination flag FDS is raised to 1, second control device 200B transitions to step S815 and step S816 in the flowchart of FIG. 23, thereby stopping supply of AC power from second inverter 200B22 to first winding set 100a and second winding set 100b.

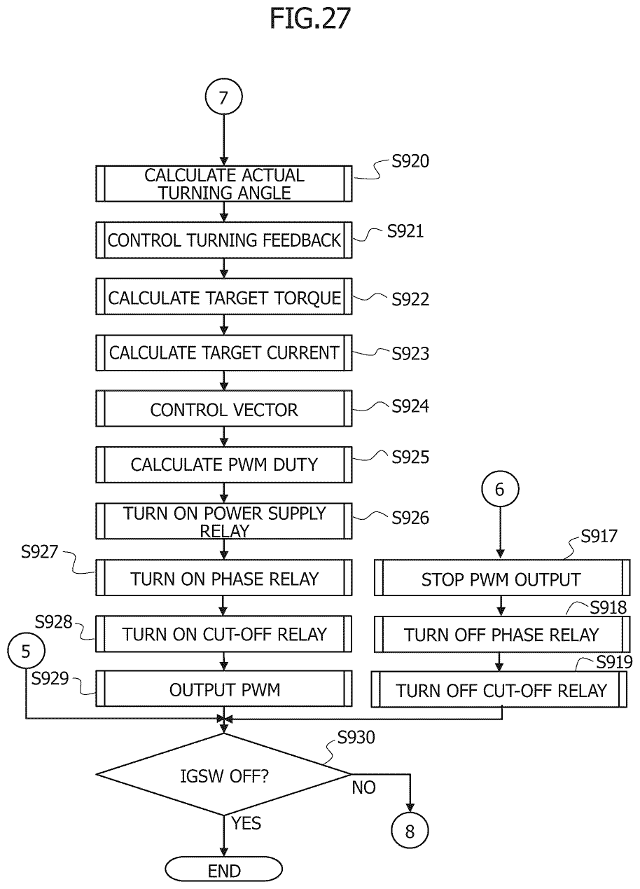

When supply of AC power from second inverter 200B22 to first winding set 100a and second winding set 100b is stopped, third control device 200C carries out processing in step S920 and subsequent steps in the flowchart of FIG. 27, thereby performing switching to the state in which AC power is supplied from third inverter 200C22 to first winding set 100a and second winding set 100b (see FIG. 10).

That is, third control device 200C controls both of third relay 200C3 and fourth relay 200C4 to be turned ON to start the PWM control on third inverter 200C22, thereby supplying AC power from third inverter 200C22 to first winding set 100a and second winding set 100b.

When driving performed by third inverter 200C22 continues and when third control device 200C raises the drive switching determination flag FDS to 1, driving of third inverter 200C22 is stopped. Instead, switching to the state in which AC power is supplied from second inverter 200B22 to first winding set 100a and second winding set 100b is performed (see FIG. 9).

Accordingly, even if a failure occurs in first inverter 200A22, supply of AC power to first winding set 100a and second winding set 100b is continued, and the temperature of semiconductor switching elements constituting the inverter that drives motor 100 can be prevented from increasing.

Similarly, the case in which a failure occurs in first inverter 200A22 in motor control device 200 of the first embodiment as illustrated in FIG. 6 will be described.

Herein, when the state in which the accumulated driving time of second inverter 200B22 exceeds the set time or the FET estimated temperature of second inverter 200B22 exceeds the set temperature continues in the state in which AC power is supplied from second inverter 200B22 to first winding set 100a and second winding set 100b, second control device 200B raises the drive switching determination flag FDS to 1 to stop the PWM control on second inverter 200B22, thereby controlling second relay 200B3 to be turned OFF.

At this time, third control device 200C controls all of third relay 200C3 and fourth relay 200C4 to be turned on to start the PWM control on third inverter 200C22, thereby supplying AC power from third inverter 200C22 to first winding set 100a and second winding set 100b.

That is, also in the first embodiment, in the state in which a failure has occurred in first inverter 200A22, the state in which AC power is supplied from second inverter 200B22 to first winding set 100a and second winding set 100b and the state in which AC power is supplied from third inverter 200C22 to first winding set 100a and second winding set 100b are alternately switched.

In motor control device 200 of the third embodiment illustrated in FIG. 17, if second relay 200B3 is controlled to be turned on to subject second inverter 200B22 to the PWM control and if third relay 200C3 and fourth relay 200C4 are all controlled to be turned on when a failure occurs in first inverter 200A22, for example, AC power can be supplied from second inverter 200B22 to first winding set 100a and second winding set 100b.

In this state, when the state in which the accumulated driving time of second inverter 200B22 exceeds the set time or in which the FET estimated temperature of second inverter 200B22 exceeds the set temperature continues, second control device 200B raises the drive switching determination flag FDS to 1 to stop the PWM control on second inverter 200B22, thereby controlling second relay 200B3 to be turned OFF.

Herein, third control device 200C holds the state in which third relay 200C3 and fourth relay 200C4 are all controlled to be turned on and starts the PWM control on third inverter 200C22, thereby supplying AC power from third inverter 200C22, in place of second inverter 200B22, to first winding set 100a and second winding set 100b.

In addition, in the motor control device of the fourth embodiment illustrated in FIG. 21, if second relay 200B3 is controlled to be turned ON to subject second inverter 200B22 to the PWM control and if third relay 200C3 and fourth relay 200C4 are all controlled to be turned ON when a failure occurs in first inverter 200A22, for example, AC power can be supplied from second inverter 200B22 to first winding set 100a and second winding set 100b.

In this state, when the state in which the accumulated driving time of second inverter 200B22 exceeds the set time or in which the FET estimated temperature of second inverter 200B22 exceeds the set temperature continues, second control device 200B raises the drive switching determination flag FDS to 1 to stop the PWM control on second inverter 200B22, thereby controlling second relay 200B3 to be turned OFF.

Herein, third control device 200C holds the state in which third relay 200C3 and fourth relay 200C4 are all controlled to be turned ON, controls eighth relay 200C8 to be turned ON, and starts the PWM control on third inverter 200C22, thereby supplying AC power from third inverter 200C22, in place of second inverter 200B22, to first winding set 100a and second winding set 100b.

As described, when a failure occurs in either one of first drive circuit 200A2 and second drive circuit 200B2, motor control device 200 alternately switches the state in which motor 100 is driven only by a normal drive circuit between first drive circuit 200A2 and second drive circuit 200B2 and the state in which motor 100 is driven only by third drive circuit 200C2.

Accordingly, even when a failure occurs in either one of first drive circuit 200A2 and second drive circuit 200B2, driving of motor 100 can be continued while reducing a rise in temperature of the semiconductor switching elements (FETs) constituting the inverter that drives motor 100.

The individual technical concepts described in the above-described embodiments can be appropriately combined and used, as long as there is no conflict.

In addition, although the content of the present invention has thus been described in detail with reference to preferred embodiments, it will be apparent to those skilled in the art that various types of modifications are possible, based on the basic technical concepts and teachings of the present invention.

For example, the steer-by-wire system can be configured as a system including a backup mechanism in which steering wheel 500 and front wheels 2L and 2R are mechanically coupled to each other via a clutch or the like.

In addition, the steering device is not limited to steer-by-wire. The steering device can be an electric power steering device in which a steering wheel and steered road wheels (front wheels) are mechanically coupled to each other and which includes a motor that generates turning force.

In addition, the semiconductor switching elements constituting the relays are not limited to MOSFETs, but insulated gate bipolar transistors (IGBTs) or the like can be used.

In addition, motor control device 200 can include four or more control devices (four systems), each of which includes an MCU, a drive circuit, and a relay.

In addition, when the MCUs constituting the control devices are multi-core MCUs, a plurality of processor cores can monitor their respective operations.

For example, between a first processor core and a second processor core constituting a dual core, if an abnormality occurs in the first processor core, the second processor core can continue to control the driving of a motor (an actuator) and can continue to monitor its pre-driver, inverter, and power supply.

### REFERENCE SYMBOL LIST

100 Motor
100a First winding set (first multi-phase winding set)
100b Second winding set (second multi-phase winding set)
200 Motor control device
200A First control device (control unit)
200A22 First inverter
200A6 Sixth relay (cut-off relay)
200B Second control device (control unit)
200B22 Second inverter
200B7 Seventh relay (cut-off relay)
200C Third control device (control unit)
200C22 Third inverter
200C5 Fifth relay (cut-off relay)
200A3 First relay (phase relay, cut-off relay)
200B3 Second relay (phase relay, cut-off relay)
200C3 Third relay
200C4 Fourth relay
1000 Steering system
2000 Steering device
3RU2, 3RV2, 3RW2 Semiconductor switching element (cut-off relay)
4RU2, 4RV2, 4RW2 Semiconductor switching element (cut-off relay)
1BU, 1BV, 1BW First branch point
2BU, 2BV, 2BW Second branch point
3BU, 3BV, 3BW Third branch point

1. A motor control device that controls a motor including a first multi-phase winding set and a second multi-phase winding set, the motor control device comprising:
a first inverter that is connected to the first multi-phase winding set and that supplies AC power to the first multi-phase winding set;
a second inverter that is connected to the second multi-phase winding set and that supplies AC power to the second multi-phase winding set;
a third inverter that is connected to a first branch point between the first multi-phase winding set and the first inverter and also to a second branch point between the second multi-phase winding set and the second inverter, and that is capable of supplying AC power to the first multi-phase winding set or the second multi-phase winding set;
switching relays that are capable of switching current supply and cut-off, the switching relays including a first switching relay that is arranged between the first branch point and the third inverter and a second switching relay that is arranged between the second branch point and the third inverter, the first switching relay and the second switching relay each having a diode that passes a current in a direction from the motor toward the third inverter;
a cut-off relay that is capable of switching current supply and cut-off, the cut-off relay being arranged between the first branch point and a ground and between the second branch point and the ground, and having a diode that passes a current in a direction from the ground toward the motor; and
a control unit that controls the first inverter, the second inverter, the third inverter, the switching relays, and the cut-off relay.

2. The motor control device according to claim 1, wherein the cut-off relay is arranged between the first branch point and a third branch point that branches from between the third inverter and the first branch point toward the second branch point, and is arranged between the second branch point and the third branch point.

3. The motor control device according to claim 1, wherein the cut-off relay is arranged between the third inverter and the ground.

4. The motor control device according to claim 3, wherein the cut-off relay includes a first cut-off relay and a second cut-off relay connected in series to each other.

5. The motor control device according to claim 3, wherein when detecting a failure in the first inverter, the control unit turns ON all of the switching relays to drive the motor by either one of the second inverter and the third inverter.

6. The motor control device according to claim 5, wherein the control unit switches driving of the motor performed by the second inverter and driving of the motor performed by the third inverter according to a temperature of the second inverter and a temperature of the third inverter.

7. The motor control device according to claim 5, wherein the control unit switches driving of the motor performed by the second inverter and driving of the motor performed by the third inverter according to a time period of driving of the motor performed by the second inverter and a time period of driving of the motor performed by the third inverter.

8. The motor control device according to claim 1, wherein the cut-off relay is arranged among the first inverter, the second inverter, and the ground.

9. The motor control device according to claim 8, wherein the cut-off relay includes a first cut-off relay and a second cut-off relay connected in series.

10. The motor control device according to claim 1, wherein the cut-off relay is arranged between the first inverter and the first branch point and between the second inverter and the second branch point.

11. The motor control device according to claim 1, wherein when detecting a failure in the first inverter, the control unit turns OFF the cut-off relay and turns ON the first switching relay to supply AC power from the third inverter to the first multi-phase winding set.

12. The motor control device according to claim 1, wherein when detecting a failure in a switching element of a lower arm of the third inverter, the control unit turns OFF the cut-off relay and the switching relays.

13. The motor control device according to claim 1, wherein when detecting a failure in a switching element of a lower arm of the third inverter and a failure in the first switching relay, the control unit turns OFF the cut-off relay and the switching relays and stops operation of either the first inverter or the second inverter.

14. The motor control device according to claim 1, wherein when detecting a failure in the first switching relay and a failure in the second switching relay, the control unit stops operation of either the first inverter or the second inverter.

15. The motor control device according to claim 1, wherein the switching relays and the cut-off relay are each composed of a semiconductor switching element having a parasitic diode.

16. A motor device comprising:
a motor including a first multi-phase winding set and a second multi-phase winding set; and
a motor control device that controls the motor and that includes
a first inverter that is connected to the first multi-phase winding set and that supplies AC power to the first multi-phase winding set,
a second inverter that is connected to the second multi-phase winding set and that supplies AC power to the second multi-phase winding set,
a third inverter that is connected to a first branch point between the first multi-phase winding set and the first inverter and also to a second branch point between the second multi-phase winding set and the second inverter, and that is capable of supplying AC power to the first multi-phase winding set or the second multi-phase winding set,
switching relays that are capable of switching current supply and cut-off, the switching relays including a first switching relay that is arranged between the first branch point and the third inverter, and a second switching relay that is arranged between the second branch point and the third inverter, the first switching relay and the second switching relay each having a diode that passes a current in a direction from the motor toward the third inverter,
a cut-off relay that is capable of switching current supply and cut-off, the cut-off relay being arranged between the first branch point and a ground and between the second branch point and the ground, and having a diode that passes a current in a direction from the ground toward the motor, and
a control unit that controls the first inverter, the second inverter, the third inverter, the switching relays, and the cut-off relay.

17. A steering system comprising:
a steering device that includes a motor including a first multi-phase winding set and a second multi-phase winding set and that is capable of steering steered road wheels of a vehicle based on an output of the motor; and
a motor control device that controls the motor and that includes
a first inverter that is connected to the first multi-phase winding set and that supplies AC power to the first multi-phase winding set,
a second inverter that is connected to the second multi-phase winding set and that supplies AC power to the second multi-phase winding set,
a third inverter that is connected to a first branch point between the first multi-phase winding set and the first inverter and also to a second branch point between the second multi-phase winding set and the second inverter, and that is capable of supplying AC power to the first multi-phase winding set or the second multi-phase winding set,
switching relays that are capable of switching current supply and cut-off, the switching relays including a first switching relay that is arranged between the first branch point and the third inverter, and a second switching relay that is arranged between the second branch point and the third inverter, the first switching relay and the second switching relay each having a diode that passes a current in a direction from the motor toward the third inverter,
a cut-off relay that is capable of switching current supply and cut-off, the cut-off relay being arranged between the first branch point and a ground and between the second branch point and the ground, and having a diode that passes a current in a direction from the ground toward the motor, and
a control unit that controls the first inverter, the second inverter, the third inverter, the switching relays, and the cut-off relay.
